(19) United States
(12) Patent Application Publication
(10) Pub. No.: US 2024/0112107 A1
(43) Pub. Date: Apr. 4, 2024

(54) INSTRUCTION SOLUTION SYSTEM AND METHOD

(71) Applicant: Instructional Design Genius, Inc., Odessa, FL (US)

(72) Inventor: Christopher Straley, Odessa, FL (US)

(21) Appl. No.: 17/937,177

(22) Filed: Sep. 30, 2022

(51) Int. Cl. G06Q 10/0631; G06Q 50/20

(52) U.S. Cl. CPC G06Q 10/06313; G06Q 50/205

(57) ABSTRACT

A system and method that make it easy and cost-effective for companies to create and assess the value of instruction solutions. The cloud-based service provides end-to-end support around the cost-side of the learning development process and a mechanism for analyzing its benefits. The system and method allow for creation and modification of a proposed instruction solution, and also includes a means to determine costs associated with such instruction solution.

### FIELD

The disclosure relates to instruction solutions, and more particularly to an instruction solution system and method that minimizes cost while optimizing effectiveness and efficiency.

### BACKGROUND

There are many platforms designed for collaboration and project management on the market. However, to capture the most customers, they offer generalized functionality that does not cater to specific industries outside of software development. As a result, these platforms support planning, time-tracking, work-flow, UX testing, code coverage, and other tasks specific to creating a software solution. They do not offer functionality aligned to the processes necessary to scope, design, and assess the impact of instruction solutions and/or change management deliverables.

Interestingly, current industry-specific solutions also do not focus on structuring the many steps necessary maximize the return on investment of instruction solution deliverables. Instead, offerings within the industry focus on the creation and/or management of the end-deliverable itself (an electronic learning (i.e., eLearning) class, a simulation, an interactive game, or an instructor-led class). For example, programs, such as Adobe Captivate and Articulate, assist users in creating eLearning content. Learning management systems, such as Cornerstone and Docebo, provide structure to organize and deliver existing instruction solution offerings. Other programs commonly used by the learning industry, such as Vyond or iMovie, support video and animation work, while learning record stores, such as Learning Locker, store instruction solutions much like a learning management system, but also track informal, social media posts with an educational component.

Current measurement practices within the field of learning development such as the Kirkpatrick/Phillips model of measurement is the most commonly used approach to quantify instruction effectiveness. It consists of a series of levels that build upon each other to provide practitioners with a consistent framework by which they can measure effectiveness. Each level aligns to a specific area of measure as follows:
Level 1—Reaction—The degree to which participants find the training favorable, engaging, and relevant to their jobs.
Level 2—Learning—The degree to which participants acquire the intended knowledge, skills, attitude, confidence, and commitment based on their participation in the training.
Level 3—Behavior—The degree to which participants apply what they learned during training when they are back on the job.
Level 4—Results—The degree to which targeted outcomes occur as a result of the training and the support and accountability package.

Educational researchers have further suggested the need to append an additional level:

JJ Phillips has argued for the addition of a Return on Investment (ROI) level, which is essentially about comparing the fourth level of the standard model to the overall costs of training.[3] Roger Kaufman has argued that ROI is essentially a Level 4 type of evaluation because it is still internal to the organization and that a fifth level of evaluation should focus on the impact of the organization on external clients and society.[1, 2, 3]
1. Ed Forest: Kirkpatrick Model: Four Levels of Learning Evaluation, Educational Technology 2. Phillips, J. (1996). How much is the training worth? Training and Development, 50 (4), 20-24.
3. Watkins, R., Leigh, D., Foshay, R. and Kaufman, R. (1998). Kirkpatrick Plus: Evaluation and Continuous Improvement with a Community Focus. Educational Technology Research & Development, 46(4): 90-96.

Learning measurement, and the Kirkpatrick/Phillips model in particular, has long been a focus of both study and application and they retain a forefront place in educational literature. It remains a key tool to assess training evaluation within and across organizations.

Nevertheless, very few organizations have the capability to adopt this approach. Several industry publications posit that due to the increasing difficulty of assessing the higher-level measures (it's much more difficult to assess impact than capture opinions), the frequency at which practitioners calculate each decreases in a linear fashion. Specifically, Impact, Results, and Return on Investment (ROI) are particularly difficult for organizations to quantify.

In 2020, Brandon Hall, a research and analyst firm with more than 10,000 clients globally and more than 20 years of delivering research-based solutions, released a report titled: Lapses in Measuring Learning's Impact Are Sabotaging America's Corporation. Brandon Hall Group's 2020 Learning Measurement Study found that fewer than 16% of organizations are very effectively able to identify and track a series of metrics, including participation, satisfaction, knowledge transfer, behavior change and business impact for any of their learning. See https://www.brandonhall.com/blogs/lapses-in-measuring-learnings-impact-are-sabotaging-americas-corporations/. The data they provide reveals an enormous gap and need as outlined in the aforementioned Organizational Ability to Measure Impact 2020 study:

Reasons for Lack of Level 3 and 4 Measurements
42% We don't have the proper metrics.
42% We don't have the time/staff.
36% We don't have the technology to support.
35% It is too difficult to link learning to outcomes.
31% It is too difficult to assess.
9% We don't see a need.

These results echo previous Brandon Hall studies over the past decade including a 2015 study that captured how often organizations completed measurement by level:
Level 1: 71%
Level 2: 41%
Level 3: 23%
Level 4: 14%

Source: 2015 Brandon Hall Group State of Learning Study (n=303)

Additional research from The Association For Talent Development claimed only 8% of organizational leaders reported seeing a level four impact measure. Fewer yet, 4%, reported seeing a Return On Investment, which is unsurprising given the need to quantify level 4 measures in order to calculate return on investment (Association For Talent Development: State of the Industry, 2017).

Despite the lack of these measures, leaders desire this information because it adds immense value to their organizations. Data regarding application (level 3), impact on results (level 4), and return on investment reveal if instruction and change management programs produce results, and at what cost. Without this information, organizations have no ability to draw a correlation between their investments in instruction solution and actual results.

Due to the gap between what organizations desire from their instruction solutions and change management teams, (behavioral, impact, and ROI measures) that demonstrate alignment to, and support of, business goals, and those same teams' current capabilities, it would be desirable to provide an instruction solution system and method that minimizes costs associated with creation of instruction and change management solutions while quantifying benefits of the solutions prior to a development thereof.

### SUMMARY

In concordance and agreement with the presently described subject matter, an instruction solution system and method that minimizes costs associated with creation of instruction and change management solutions while quantifying benefits of the solutions prior to a development thereof, have surprisingly been discovered.

The presently described subject matter does not output the ultimate instruction solution-deliverable for learners, but offers a structured process to minimize the cost of its creation while also illustrating the impact it makes once implemented within an organization. It creates efficiency by offering a structured, repeatable framework to execute a generic process. These capabilities address a stated need and important question with which the learning industry has struggled for some time: how do learning professionals better demonstrate the value they deliver?

The presently described subject matter is a cloud-based platform that provides a system for learning professionals to maximize instruction solution benefits and illustrate the impact of their work. It provides a series of tools that create speed and efficiency, capture the opportunity cost associated with design and development, track budget, and provide an interface for storyboard development. The platform also captures feedback about how successfully learners apply new skills and abilities on the job, enabling learning professionals to revise the instruction solutions after conducting an initial pilot.

The platform also allows learning professionals to align learning objectives to specific performance measures and employee behaviors, both key in quantifying the value of a given instruction solution deliverable.

Additionally, the platform includes two custom requirements-based time and cost calculators. These calculators estimate costs in both hours and costs necessary to build eLearning solutions and instructor-led training solutions. Users can run either calculator prior to beginning a project in earnest. This pre-scoping capability provides visibility into the cost of building custom instruction solutions before commencing the work and enables leadership to plan for (or cancel) learning projects before they get under-way. Due to the time and cost associated with building instruction and change management solutions, the ability to project expected costs and weigh them against anticipated impact represents critical business intelligence.

These innovative processes are more efficient, effective, accurate and functional than the current art and fulfill a need outlined repeatedly by learning and business leaders in various industry publications.

In one embodiment, a method of instruction solution development, comprises: providing at least one computing device in communication with a memory; and at least one program stored in the memory, the program having a plurality of components, wherein one of the components is a project management module, and another one of the components is a parameter module; receiving from at least one source, via the at least one computing device, one or more features of a proposed instruction solution; accessing from the memory at least one value associated with the one or more features of the proposed instruction solution; generating, via the at least one program and the at least one computing device, at least one estimated parameter to develop the proposed instruction solution using the at least one value associated with the one or more features of the proposed instruction solution; and transmitting, via the at least one program and the at least one computing device, at least one communication prior to a development of the proposed instruction solution, wherein the communication includes at least one of the estimated parameters for determination of whether the development of the proposed instruction solution is desired.

As aspects of some embodiments, the project management module uses at least one of scoping tools, questionnaires, timelines, design templates, development templates, measurement tools, and implementation guides.

As aspects of some embodiments, the project management module is configured to determine if development of the proposed instruction solution is necessary.

As aspects of some embodiments, the project management module includes a learning objective tool.

As aspects of some embodiments, the project management module includes a learning objective tool that provides a foundation of the proposed instruction solution by outlining at least one target that correlates to at least one of an objective of at least one of at least one operator and the at least one end user.

As aspects of some embodiments, the project management module includes at least one of an electronic-learning development checklist, an instructor-led instruction development checklist, and a learning management system checklist.

As aspects of some embodiments, the project management module includes at least one storyboard tool, and wherein the at least one storyboard tool provides a structure to create at least one of a script, an outline of visual concepts, and a structure of content flow.

As aspects of some embodiments, the project management module includes a storyboard tool that provides predefined common edits for learning scripts and centralizes reviewer feedback.

As aspects of some embodiments, the project management module includes at least one instructor-led instruction template.

As aspects of some embodiments, the project management module includes a production review tool that captures feedback from at least one operator of a developed instruction solution.

As aspects of some embodiments, the project management module includes a communication campaign tool that enables at least one operator to create messaging associated with a developed instruction solution which is then provided along with the developed instruction solution to the at least one end user.

As aspects of some embodiments, the project management module includes an end user prioritization that defines at least one target end user.

As aspects of some embodiments, the project management module includes functional testing for quality control of a developed instruction solution.

As aspects of some embodiments, the project management module includes user experience testing that captures feedback from the at least one end user of the developed instruction solution.

As aspects of some embodiments, the parameter module is configured to provide a timeline for an electronic-learning solution.

As aspects of some embodiments, the parameter module calculates the cost estimate of the proposed instruction solution based upon at least one of requirement inputs and a labor rate of at least one operator tasked to develop the proposed instruction solution.

As aspects of some embodiments, the parameter module is configured to estimate labor hours required to develop the proposed instruction solution.

As aspects of some embodiments, the project management module includes a measuring instruction impact tool that provides a framework to measure the return on investment of the developed instruction solution.

As aspects of some embodiments, the one or more features of the proposed instruction solution includes at least one of a desired time duration thereof, an audio narration, pre-recorded audio, a desired level of interactivity, a desired level of custom animation, a desired level of graphics, at least one imbedded video, a support of a cultural shift that requires a change management plan, a number of learning resources, a desired level of measurement, a desired form of delivery, a use of existing subject matter expert-provided content, a complexity of instruction topic, a use of pre-existing templates, a use of a rapid development tool, a desired level of trainer-to-trainer support, a desired location for delivery, a use of a learning management system to house and distribute the instruction solution, and a time dedication for development.

In another embodiment, an instruction development system, comprises: at least one computing device in communication with a memory; and at least one program stored in the memory, the program having a plurality of components, wherein one of the components is a project management module, and another one of the components is a parameter module, wherein the instruction development system is configured to: receive from at least one source, via the at least one computing device, one or more features of a proposed instruction solution; access from the memory at least one value associated with the one or more features of the proposed instruction solution; generate, via the at least one program and the at least one computing device, at least one estimated parameter to develop the proposed instruction solution using the at least one value associated with the one or more features of the proposed instruction solution; and transmit, via the at least one program and the at least one computing device, at least one communication prior to a development of the proposed instruction solution, wherein the communication includes at least one estimated parameter for determination of whether the development of the proposed instruction solution is desired.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1a shows an illustration of one embodiment of an architecture of a computing system;

FIG. 1B shows a block diagram of various embodiments of a computing device comprising a smartphone, tablet, laptop, etc.;

FIG. 1c shows a block diagram of a computing system including a project management module 150 and a parameter module 160;

FIGS. 2-37 shows exemplary screenshots of the system;

FIG. 38 shows an exemplary lookup table used to calculate a value associated with at least one feature of a proposed instruction solution;

FIGS. 39-48 shows a process flow of the system according to an embodiment of the presently disclosed subject matter; and

FIG. 49 shows another exemplary lookup table sued to calculate a value associated with at least one feature of a proposed instruction solution.

### DETAILED DESCRIPTION

The following description of technology is merely exemplary in nature of the subject matter, manufacture and use of one or more present disclosures, and is not intended to limit the scope, application, or uses of any specific disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Various embodiment of a computing system may be implemented using hardware and software components that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

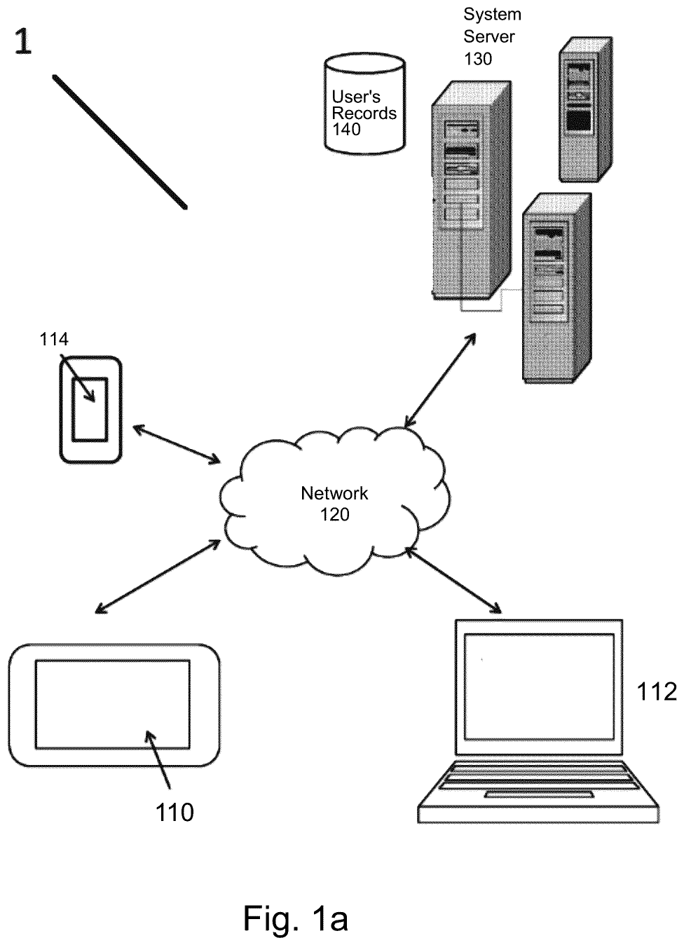

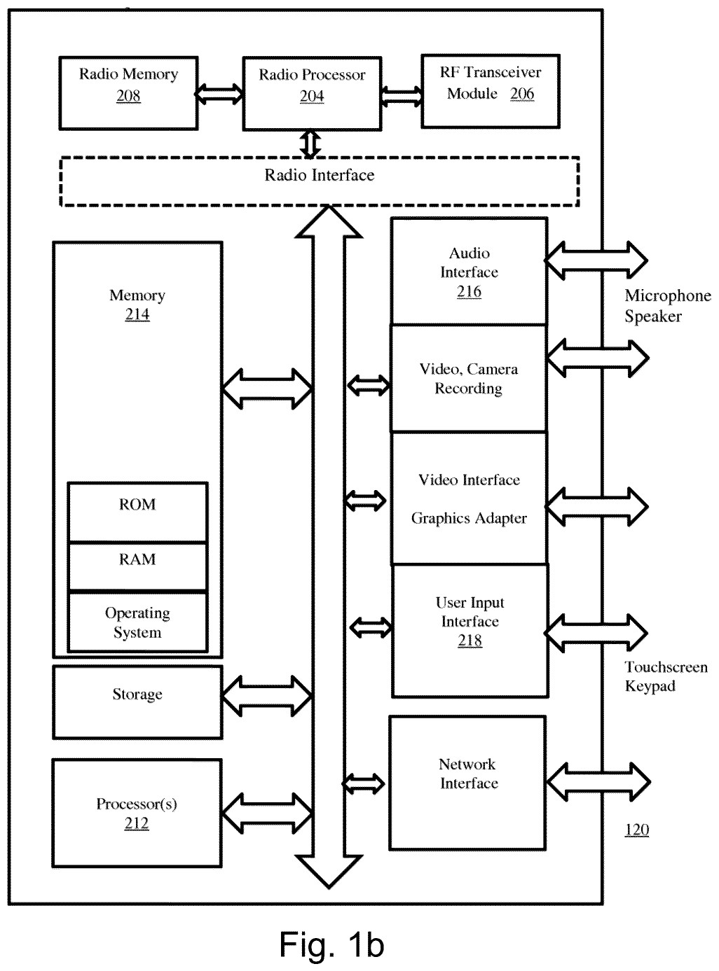

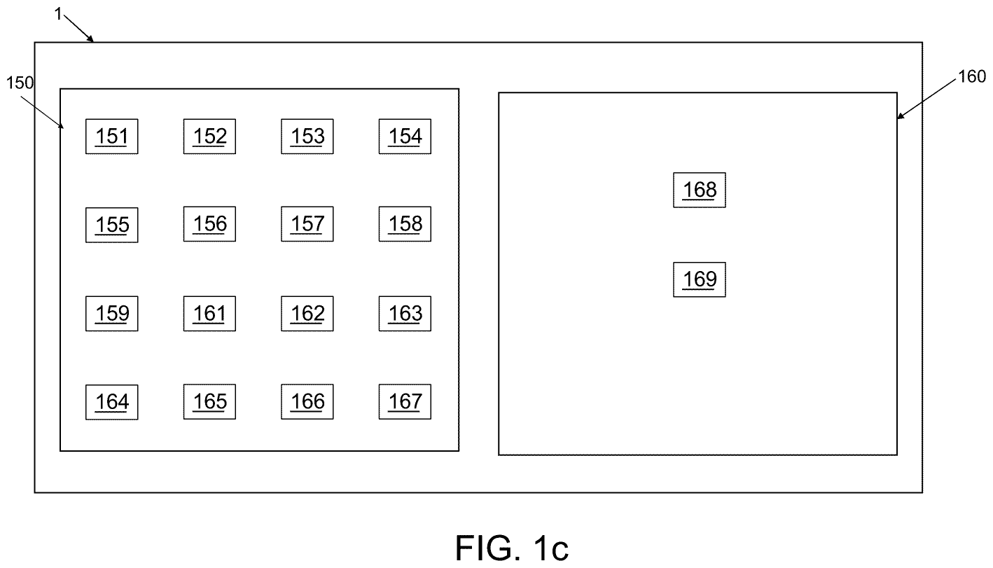

FIG. 1a illustrates an example embodiment of a computing system 1 for various embodiments of the present disclosure comprising the following components: one or more user's electronic computing devices with network connectivity 110 (e.g. a tablet), 112 (e.g. a laptop), 114 (e.g. a smartphone); a system server 130 housing user's records, wherein the server 130 housing user's records within a database 140, and the user's devices 110, 112, and 114 communicate via a network 120.

The electronic computing devices 110, 112, and 114 may communicate with the server 130, or each other (e.g. Peer-to-peer) to send and receive data and computer instruction via the network 120. The network 120 may be a wireless (cellular, satellite, microwave, infrared, radio, etc.) network, local network, wide-area network, the Internet, or any other suitable communication network or networks, and may be implemented on any suitable platform including wired and/or wireless networks.

In addition to internet connectivity, the electronic computing devices 110, 114, may also communicate via a network 120 comprising radio wave transmission components dedicated to cellular telephone functions. The basic components shown provide the ability for the mobile computing device 110, 112, and 114 to perform radio-frequency communications, including telephonic communications. As illustrated in FIG. 1B, the radio components include a baseband-radio processor 204, an RF transceiver module 206, a radio flash memory 208, and an antenna. The radio processor 204 modulates data to be transmitted and demodulates data received in accordance with the protocols of the cellular telephone standard employed by the device 110, 114. For example, the radio processor 204 may be a CDMA baseband processor that modulates and demodulates data according to the CDMA standard. The processor 204 may perform other functions to control the operation of the radio portion of the user's device, such as determining and gathering information on the performance or characteristics of the cellular communication. The RF transceiver 206 amplifies and transmits the data modulated by the processor 204 through the antenna and also receives cellular communication data through the antenna for demodulation by the radio processor 204.

The various embodiments may thus comprise a client-server system architecture where some computing or processing steps occur on the user's device 110, 112, 114 and some on the system server 130. Additionally, or alternatively, all of the computing processing steps may occur on the user's client device 110, 112, 114 and/or on the system server 130.

Computer code comprising instructions for the processor(s) to carry out the various embodiments, aspects, features, etc. Of the present disclosure may reside in the memory of the user's device 110, 112, 114 and/or on the server 130. The code may be broken into separate routines, products, etc. to carry forth specific steps disclosed herein, and/or the code may be consolidated into one product for all aspects of the present disclosure.

Turning now to FIG. 1c, the system 1 may employ a publisher algorithm-module 160, which may co-reside with, or be a part of, a project management module 150 installed on the user's electronic computing device 110, 112, 114, and/or on the system server 130 accessible via the network 120. The project management module 150 and/or a parameter module 160 may also be provided on a CD-ROM or other computer readable medium, such that it may be operated from the CD-ROM and/or installed on a user's electronic computing device 110, 112, and 114 for operation. In yet another embodiment, the modules 150, 160 may comprise a computer program and/or code that may be downloaded via the network 120 to a user's electronic computing device 110, 112, 114 for use thereon. Still other ways in which components of the system 1 of the various embodiments may be provided, accessed, and/or operated.

The present disclosure may further comprise an application installed on a user's electronic computing device, such as a smartphone 114 or tablet PC 110 or laptop computer 112, but may also include other computing devices such as a PDAs, ultra-mobile PCs UMPCs), laptop computers, desktop computers, servers. etc. It will be understood that the architecture illustrated in FIG. 1a is provided for example purposes only and does not limit the scope of the various implementations of the communication systems and methods.

Device 110, 112, and/or 114 comprises a processing circuit comprising a processor 212, and a memory 214 that stores machine instructions that when executed by the processor 212, cause the processor 212 to perform one or more of the operations and methods described herein. Processor 212 may optionally contain a cache memory unit for temporary local storage of instructions, data, or computer addresses. For example, using instructions retrieved from memory 214, the processor 212 may control the reception and manipulation of input and output data between components of the device 110.

In various embodiments, the processor 212 can be implemented as a single-chip, multiple chips and/or other electrical components including one or more integrated circuits and printed circuit boards.

The processor 212 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 214 encompasses one or more storage mediums and generally provides a place to store computer code (e.g., software and/or firmware) and data that are used by the device 110, 112, 114. It may comprise, for example, electronic, optical, magnetic, or any other storage or transmission device capable of providing the processor 212 with program instructions. Memory 214 may further include a floppy disk, CD-ROM, DVD, magnetic disk, memory chip, ASIC, FPGA, EEPROM, EPROM, flash memory, optical media, or any other suitable memory from which processor 212 can read instructions in computer programming languages.

Memory 214 may include various other tangible, non-transitory computer-readable media including Read-Only Memory (ROM) and/or Random-Access Memory (RAM). As is well known in the art, ROM acts to transfer data and instructions uni-directionally to the processor 212, and RAM is used typically to transfer data and instructions in a bi-directional manner. In the various embodiments disclosed herein, RAM includes computer program instructions that when executed by the processor 212 cause the processor 212 to execute the modules 150, and/or 160.

Processor 212 is generally coupled to a variety of interfaces such as graphics control (e.g. graphical processing unit (GPU)), video interface, audio interface 216, user input interface 218, and other interfaces, such as camera hardware and software components housed within and/or connected to devices 110, 112, 114 for recording and transmitting content. The audio interface 216 may convert sound into electrical signals using a microphone and for converting electrical signals into sound using a speaker. The input interface 218 may receive user input commands via touchscreen, a physical keyboard, virtual keyboard, etc.

Processor 212 is also coupled to a network interface that allows the processor to be coupled to another computer or telecommunications network (e.g., internet).

More particularly, the network interface generally allows processor 212 to receive information from and to output information to the network in the course of performing various method steps described in the embodiments herein. In particular, the present embodiments disclosed herein may emit a computer generated voice to communicate with the user, such as asking the user follow-up questions, and the user may respond by speaking into the device's microphone, and/or typing on a physical or virtual keyboard, and/or by touchscreen selection.

Device 110, 112, 114 may further have installed within the device's memory computer instructions for executing the various embodiments of the disclosure comprising a native application, a web application, or a widget type application to carry out the methods of the embodiments disclosed herein, or an app incorporating both the functionality of the modules 150, 160). In a preferred embodiment, a native application (e.g. computer program product) is installed on the device, wherein it is either pre-installed on the device or it is downloaded from the Internet via email and activated with a code generated by the system server. It may be written in a language to run on a variety of different types of devices; or it may be written in a device-specific computer programming language for a specific type of device.

In another embodiment, a web application resides on a remote server 130 accessed via the network 120. It performs basically all the same task as a native application, usually by downloading part of the application to the end user's device 110, 112, 114 for local processing each time it is used. The web application software is written as Web pages in HTML and CSS or other language serving the same purpose, with the interactive parts in JavaScript or other language. Or the web application can comprise a widget as a packaged/downloadable/installable web application; making it more like a traditional application than a web application; but like a web application uses HTML/CSS/JavaScript and access to the Internet. And/or device 110, 112, 114 may include a web browser running applications (e.g. Java applets or other like applications), comprising application programming interfaces (APIs) to other software applications running on remote servers 130 that provide, for example, cloud based services and comment posting.

The system 1, data and processing code can reside in the non-transitory memory 214 of the one or more computing devices 110, 112, and 114. The system 1 may work with a central remote server 130 as shown in FIG. 1a or in parallel which each computing device 110, 112, 114 or smartphone communicating with others within the system 1. Any programing language and operating system can be used to run the system 1.

This present disclosure is a system 1 and method aimed to make it easy to scope and evaluate instruction solutions, including but not limited to, eLearning instruction solutions as well as instructor-led (IL) instruction solutions. It is a system 1 and method in which the user can scope and evaluate instruction solutions, including but not limited to, generate and/or calculate estimates for time and costs required to complete a construction of the instruction solutions. The system 1 will include each user feature separate from the other or combined.

The system 1 may comprise the processor 212 in communication with the memory 214 and at least one program stored in the memory 214, the at least one program having a plurality of components, wherein one of the components is the project management module 150, and another one of the components is the parameter module 160.

In some embodiments, the project management module 150 may be structured specifically to minimize costs associated with the planning, building, and measurement of instruction solutions. Specifically, to manage the cost-side of the Return-On-Investment (ROI) equation, the system 1 structures the scoping process, captures the opportunity cost associated with instruction, tracks budget, supports storyboard development, organizes instruction deployments in a repeatable way to assist learning professionals in creating instruction solutions as efficiently as possible. The system 1 may have one or more time and cost calculators such as an eLearning Calculator 168 and/or an instructor-led instruction calculator 169. On the return-side of the ROI equation, the system 1 displays correlative relationships between instruction and business results as well as predictions about how new behaviors will (or won't) drive business performance.

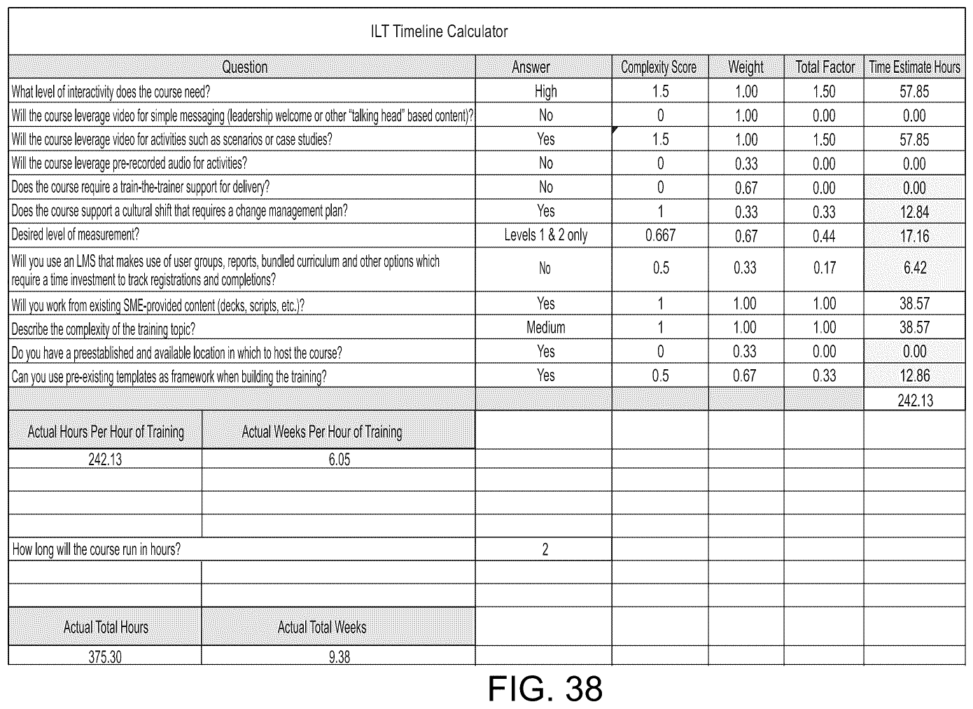

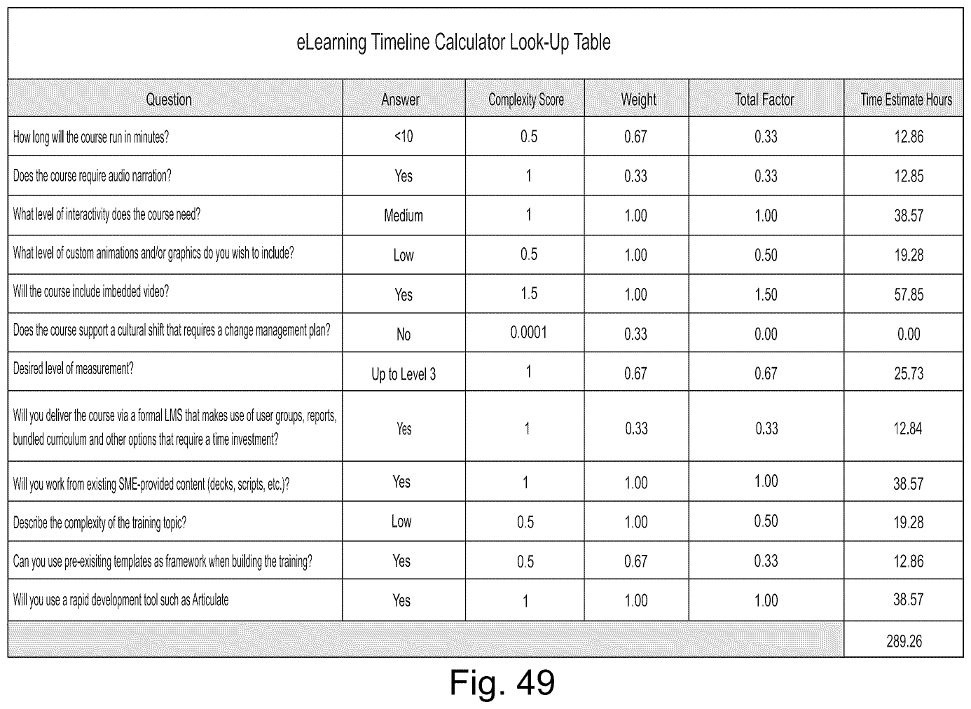

The parameter module 160 may utilize custom requirements-based time and cost calculators 168, 169 and/or lookup tables, as shown in FIGS. 38 and 49, respectively, to generate and/or calculate at least one of a timeline and one or more estimated parameters such as estimated costs in both hours and money, for example, necessary to build the instruction solutions which users can run prior to beginning a project in earnest. This pre-scoping capability provides visibility into the cost of building custom instruction solutions before commencing the work and enables leadership to plan for (or cancel) learning projects before they get under-way. The parameter module 160, and more particularly, the timeline and cost calculators 168, 169 apply requirement inputs selected by the operator from pre-defined options, as well as user-input labor rates to calculate total costs in both hours and money necessary to build the instruction solutions.

A user, an operator, and/or instructor (hereinafter collectively “user”) may scope and evaluate instruction solutions for employees, as well as estimate costs and labor hours required to construct the instruction solutions prior to a development thereof. It is understood that each user feature may be provided separately from one another or combined.

In some embodiments, the method may require that a user would register and login.

At an exemplary home page, public content includes a search option with criteria, a “company overview, product information, sample offerings, and research links.” There may also be links to log-in or follow a link to register. Membership may begin with a free trial. The user can go to a “shopping cart” site, which allows viewing prior subscriptions, to select memberships by monthly or annual payments, and pay through traditional invoice payments or online through an online payment service. Upon payment, members will receive an invoice. After successful subscription, the user will receive a unique login ID with a password, which can be changed.

At log-in screen, the user inputs username and password to access member area. The system 1 checks to ensure account is only logged in once at a time (can only operate on a single device at a time). A link may be available to request to recover a password.

Upon creating and logging into an account, access is granted to a member-only areas that may access the project management module 150 and/or the parameter module 160.

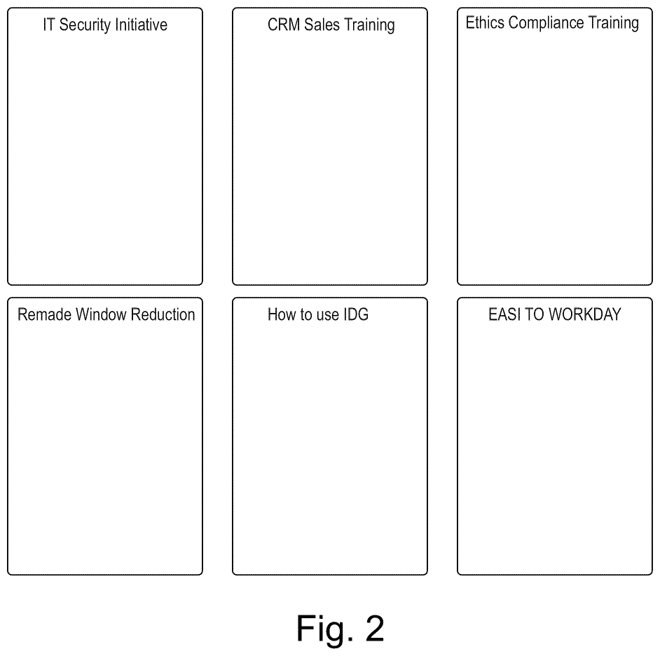

FIGS. 2 through 37 show exemplary screenshots of the system 1. It should be appreciated that the system 1 may employ more or less links and/or pages as desired.

In some embodiments, the project management module 150 may include a plurality of sub-components and/or use at least one of scoping tools, questionnaires, timelines, design templates, development templates, measurement tools, and implementation guides.

In certain embodiments, the project management module 150 may include Solicit Performance Support sub-component 151, which speeds up the process for both an end user and the learning professionals who filed requests by gathering key information necessary to start analysis on day one.

FIG. 2 depicts an exemplary dashboard of the project module 150. In some embodiments, the dashboard may indicate a name of each project in a separate and distinct tile. From the dashboard, the user may select to create a new project.

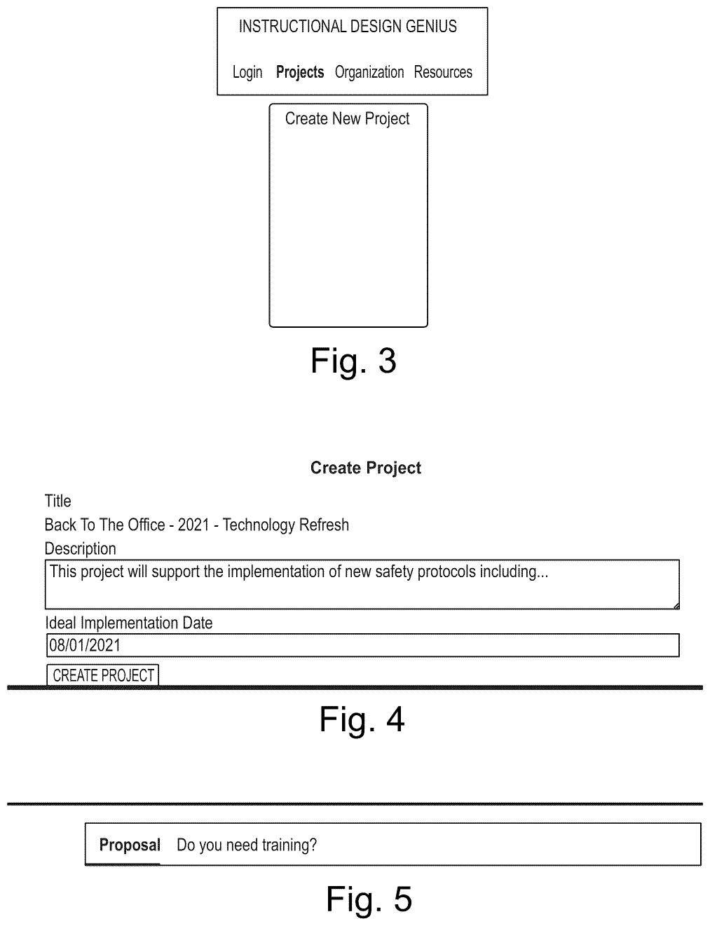

FIG. 3 shows a user interface to create a new project. Upon clicking on “Create A New Project” the user will enter a title, description, and ideal implementation date before moving directly into the scoping tools.

FIG. 4 shows a landing screen for the new project where a user enters general project information;

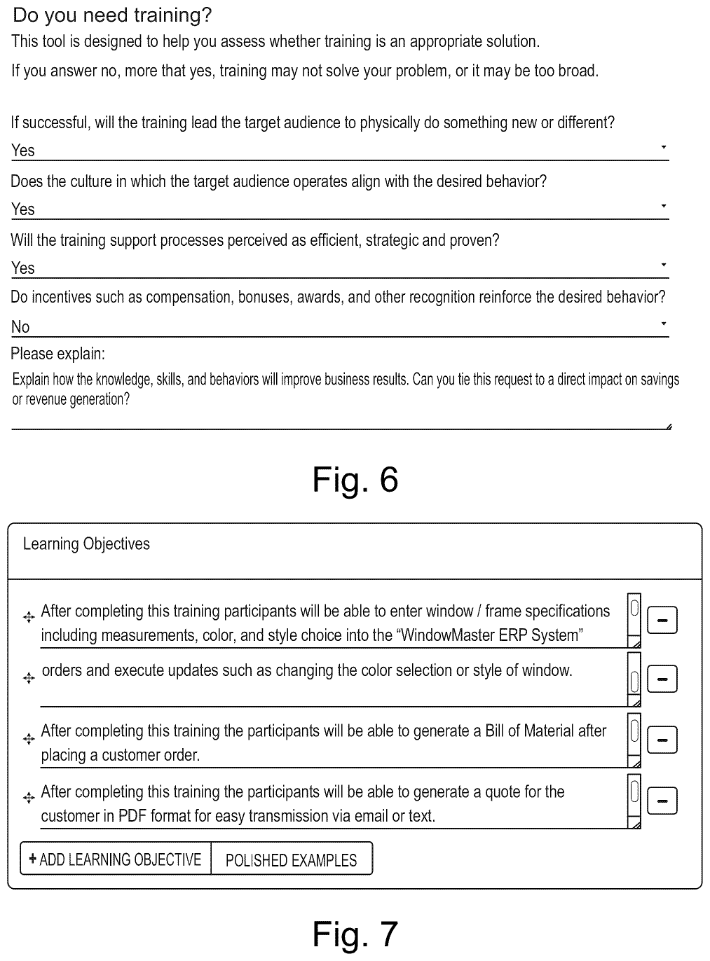

As part of the project management module 150, the system 1 will ask “Do You Need Training?” Exemplary screenshots of which are shown in FIGS. 5 and 6. Contrary to popular belief, instruction solutions do not solve all performance issues. The project management module 150 progresses through specific questions to determine if an instruction solution is needed to meet the user's needs. The project management module 150 may be a tool by which the user can evaluate a likelihood that the instruction solution would produce a desired outcome of a project.

A Learning Objective Tool 152 of the project management module 150, an exemplary screenshot of which is shown in FIG. 7, provides a foundation for the proposed instruction solutions by outlining at least one target that correlates to at least one of an objective of at least one of at least one user and the at least one end user such as a business need or other stated goal of the user and/or end user. FIG. 7 shows the interface to create action-oriented learning objectives for the proposed instruction solutions. Action-oriented objectives increase an ability to evaluate ROI because they are observable, measurable, and can correlate with a desired outcome.

Solution Proposal 153 sub-component provides users, sponsors and others with a clear, concise summary that outlines how a proposed instruction solution will support knowledge and skill development.

The project management module 150 and/or the parameter module 160 may provide timelines that help everyone involved stay on task and learn about their role in the learning development process. At least one of the modules 150, 160 of the system 1 may include custom project timelines for both instructor-led instruction solutions and electronic instruction solutions.

The project management module 150 may also include an eLearning Development Checklist 154 sub-component. Creating an engaging electronic instruction solution takes a lot more effort than posting a presentation or instructor-led instruction solution online. The users learn all about it and hone their process by using the eLearning Development Checklist 154.

A Roles & Responsibilities 155 sub-component of the project management module 150 sets clear role definitions that promotes effective project management. Start everyone on the same page by outlining responsibilities of four key roles: instruction designer, eLearning developer, project sponsor and subject matter expert.

The project management module 150 may further include an Instructor-Led Development Checklist 156 sub-component configured to provide a checklist used for a strong instructor-led instruction solution that is engaging, informational, interactive, easy-to-deliver, and digestible for the learner.

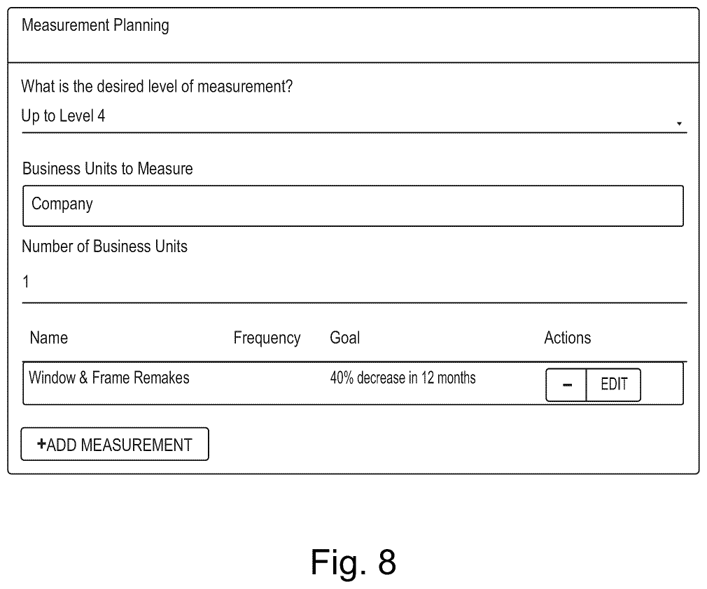

FIG. 8 shows the metric-based, measurement planning interface by which the user can identify targeted goals for the instruction solution deliverable.

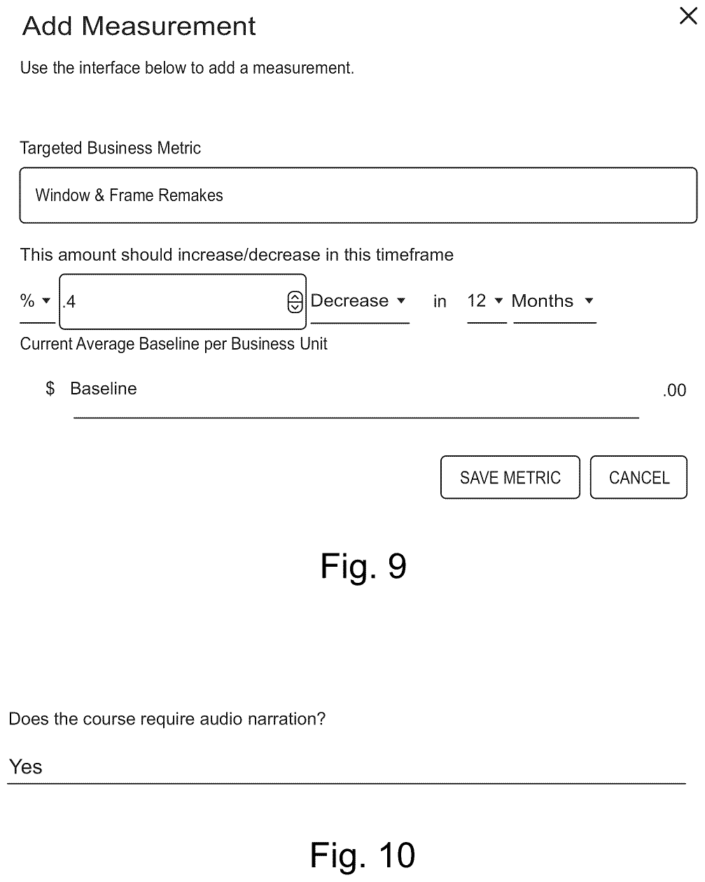

FIG. 9 shows the interface by which users can enter the desired change in a specific metric, including by percentage and dollar value. These features provide flexibility to measure instruction's ability to increase or decrease the performance of a specific metric. For instance, in some initiatives one wants to achieve a decrease such as complaints, errors, time spent, etc. while in others, one wants to affect an increase such as recommendations, conversion, or raw sales.

FIGS. 10-21 show the eLearning time and cost calculator 168, an estimation tool that applies a requirements-based algorithm to estimate the amount of time and money it takes to build an eLearning deliverable of a given fidelity. In this context, as in software development, fidelity refers to the degree of polish, complexity, and functionality of a given solution. The greater the fidelity the more time and money are required. The calculator 168 provides estimates in both hours and money necessary to build eLearning solutions. Users calculate these estimates prior to beginning an eLearning project in earnest. This pre-scoping capability provides visibility into the cost of building custom instruction solutions before commencing the work and enables leadership to plan for or cancel learning projects before they get under-way. This capability also enables organizations to compare the time and cost to deliver different fidelities of instruction solutions (e.g., the time and cost for an hour-long eLearning that includes interactive exercises versus a simpler information-centric 15-minute course). For example, answering, “Yes” to the question, “Does the course require audio narration?” will add time to the estimated time to build, whereas answering, “No” will not.

FIG. 10 shows a single input of the eLearning Time and Cost Calculator 168 specific to the work effort associated with creating and embedding audio narration into an instruction solution. The algorithm behind these inputs also uses weighted adjustments because not all requirements impact time and cost equally. For example, answering, “Yes,” to the question, “Does the course require audio narration,” will add time, but less so than answering, “Yes” to the subsequent question, “What level of custom animations and/or graphics do you wish to include.” On average, creating custom animation is more time-consuming than recording audio and the system can navigate this complexity accordingly. It can save these inputs and continue on to more inputs. Not only does each parameter coincide with a value that changes based upon how one answers a requirements-based questions, the parameters and/or adjustments are not all weighted the same. For example, there may be a plurality of “categories” to account for the fact that if the user were to need custom animation, which is going to add a lot more time to the project than needing an audio voiceover.

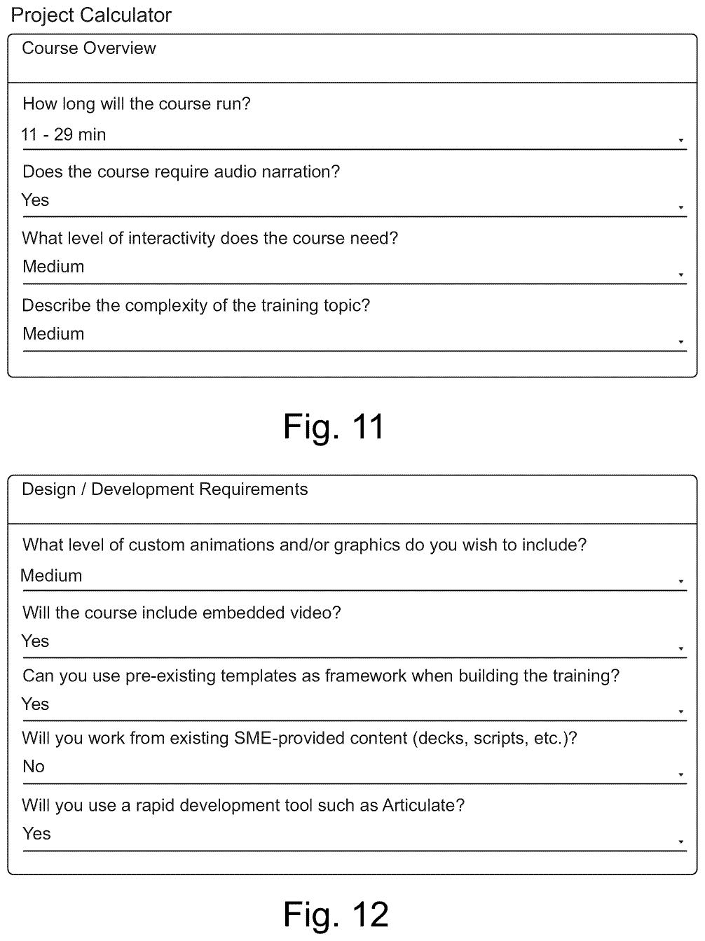

FIG. 11 shows the aforementioned audio input of the eLearning Time and Cost Calculator 168 as well as additional inputs related to general course characteristics that impact the time and cost necessary to create an instruction solution. Inputs include course duration, audio narration, desired interactivity levels, and topic complexity.

FIG. 12 shows design and development inputs for the eLearning Time and Cost Calculator 168, each of which impacts the time and cost necessary to create an instruction solution. These include custom animation needs, the use of video, pre-existing template availability, subject-matter expert support, and the availability of rapid development tools. Several of the aforementioned factors such as preexisting templates and rapid development tools actually lessen the time and cost necessary to build a solution. The calculator's algorithm is able to quantify these impacts as time savings, and rather than simply add hours to development, answering, “yes” to them can reduce time. The calculator 168 not only factors in that not all requirements impact time and costs to the same degree, but some attributes such as template availability or the availability of specific development tools, can reduce time and costs associated with development.

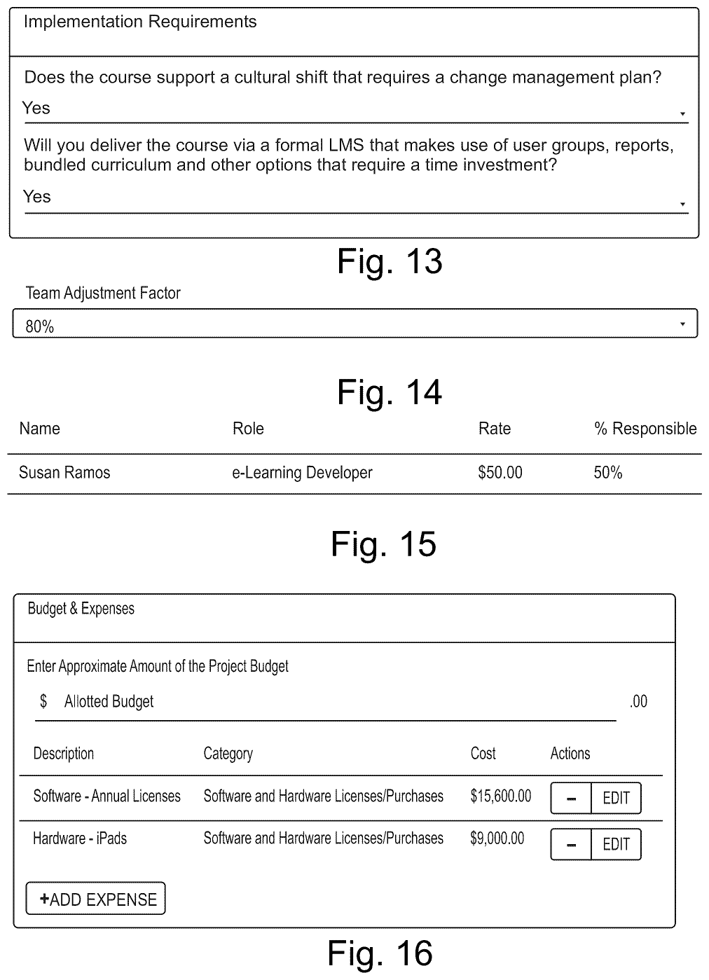

FIG. 13 shows implementation inputs for the eLearning Time and Cost Calculator 168 each of which impacts the time and cost necessary to create an instruction solution. These include the need to create a change management plan to accommodate the instruction solution rollout, as well as the availability of a learning management system (LMS), to distribute courses instantaneously to a geographically-diverse audience.

FIG. 14 shows the Team Adjustment Input that allows users to override the algorithm behind the eLearning Time and Cost Calculator 168 based upon expertise. This capability allows users to act on intrinsic knowledge they have about a learning professional's abilities and how they may impact the project. For example, an experienced eLearning developer may receive a score of 0.8 or 80% because they can output the deliverable in only 80% of the time predicted by the eLearning Time and Cost Calculator 168. A less experienced professional might require 120% of the predicted time to account for their inexperience in the field.

FIG. 15 shows the inputs to assign a course developer, capture her hourly rate, and determine the percentage of the project she is responsible to complete. The rate and percentage responsible inputs factor into the algorithm that outputs a cost estimate to create the eLearning course. In addition to costs calculated by the calculator inputs, the platform also allows users to enter known one-time expenses.

FIG. 16 shows the budget and expense summary tile which depicts line-item costs such as supplementary instruction materials or software licenses.

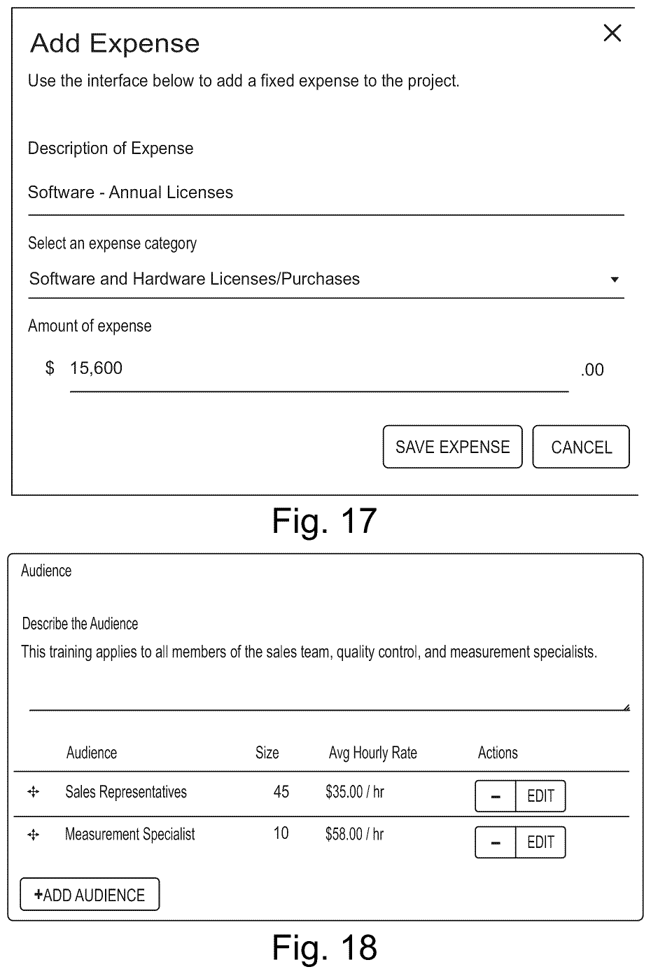

FIG. 17 shows the budget and expense tile for each individual expense which allows the user to enter costs specific to each item. Besides costs associated with creating an instruction solution, learning professionals must also account for the productivity lost when learners complete the instruction solution since they are still being paid, but not completing the “day job” tasks that produce value for an organization.

FIG. 18 shows the summary screen for the target audience of the instruction, including both audience size and average hourly compensation.

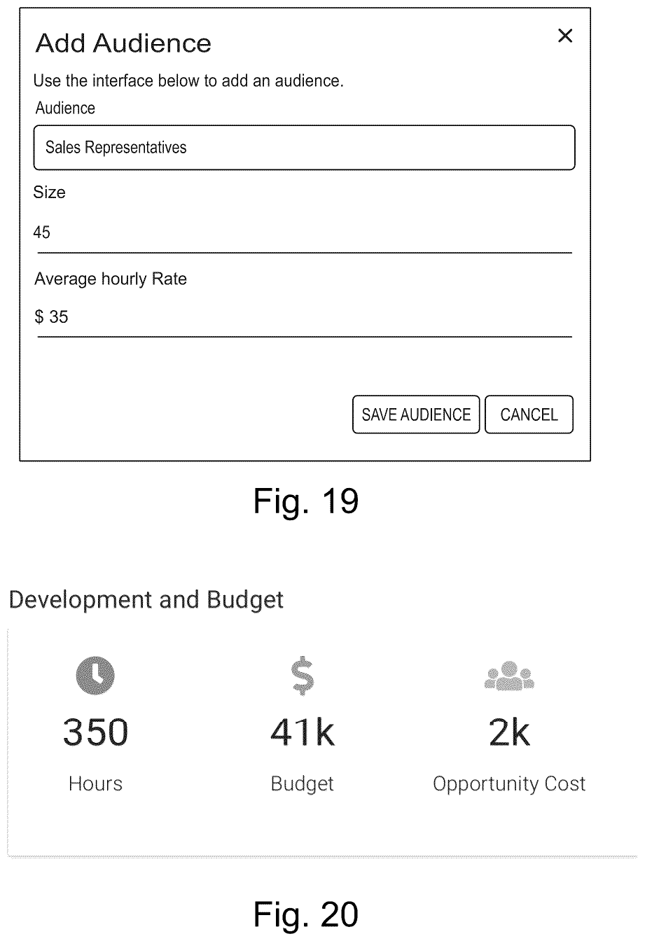

FIG. 19 shows the interface that allows the user to enter information specific to each instruction audience, including both size and average hourly compensation. This enables the user to calculate the opportunity cost of delivering an instruction. For example, if 100 employees make an average of $25 per hour and they must dedicate one hour to take the instruction, the immediate opportunity cost is a minimum of $2500 in lost productivity.

FIG. 20 shows the summary output of the eLearning Time and Cost Calculator 168, budget and expense tiles, and target audience tiles. It shows estimated instruction creation time, budget, and opportunity cost to deliver the instruction.

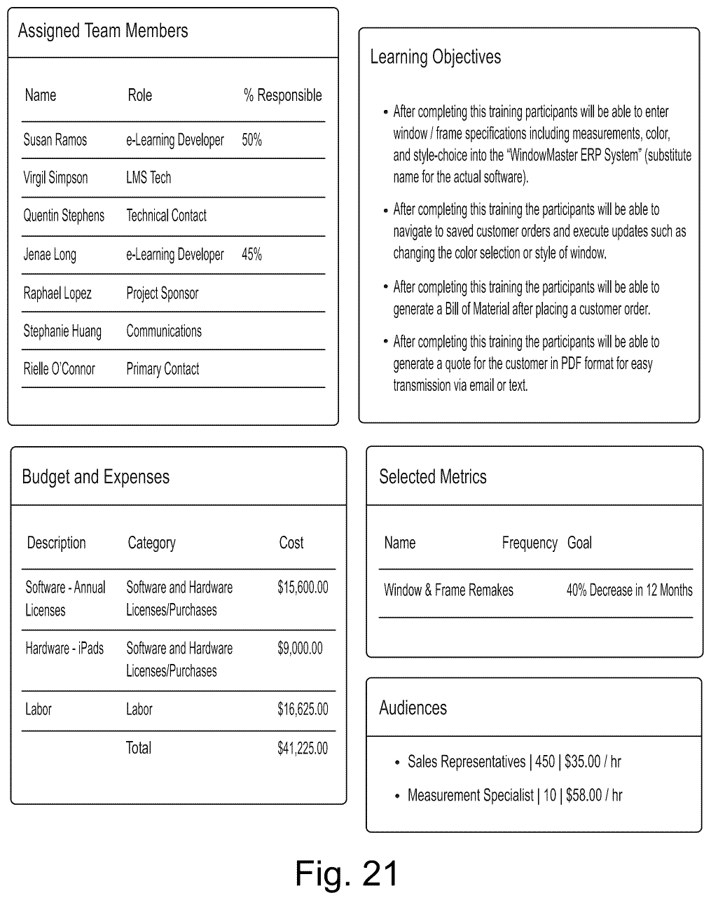

FIG. 21 shows another view of the project summary screen including the assigned project team, learning objectives, expenses, measurement metrics, and target audience. At this point in time, platform users have a succinct project summary including the potential costs and desired impact of an instruction intervention. They can use it in consultation with leadership at their organization to decide whether or not to proceed with creating and implementing an instruction of a specific fidelity.

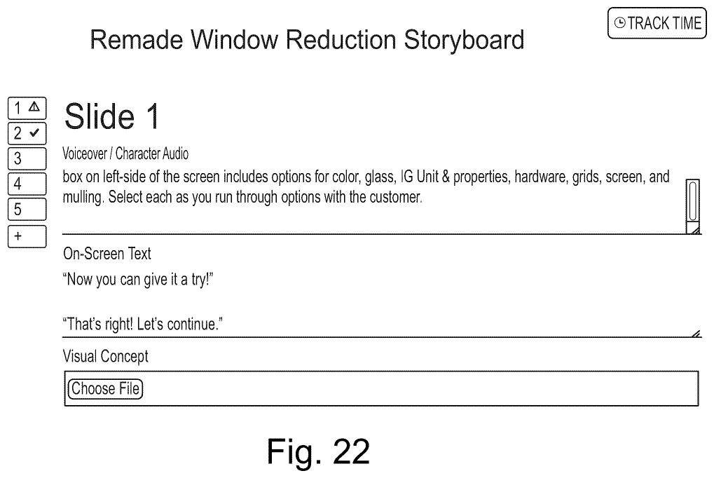

FIG. 22 shows an interface for a Storyboard Tool 157 sub-component in which the user can create a script for the instruction solution complete with voiceover, on-screen text, on-screen images, and special instructions such as animation as well as preform other function such as capture sponsor and peer feedback during the design phase to create alignment and avoid unnecessary rework. The Storyboard Tool 157 sub-component may provide predefined common edits for learning scripts and centralizes reviewer feedback. The value-add of the predefined common edits are meant to save time and categorize edits by type.

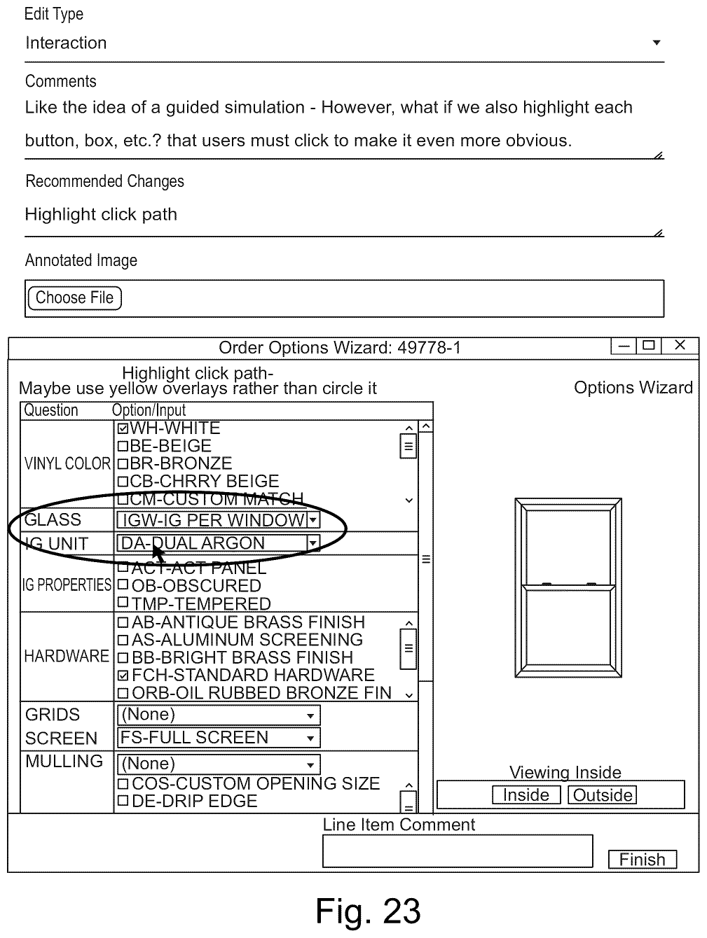

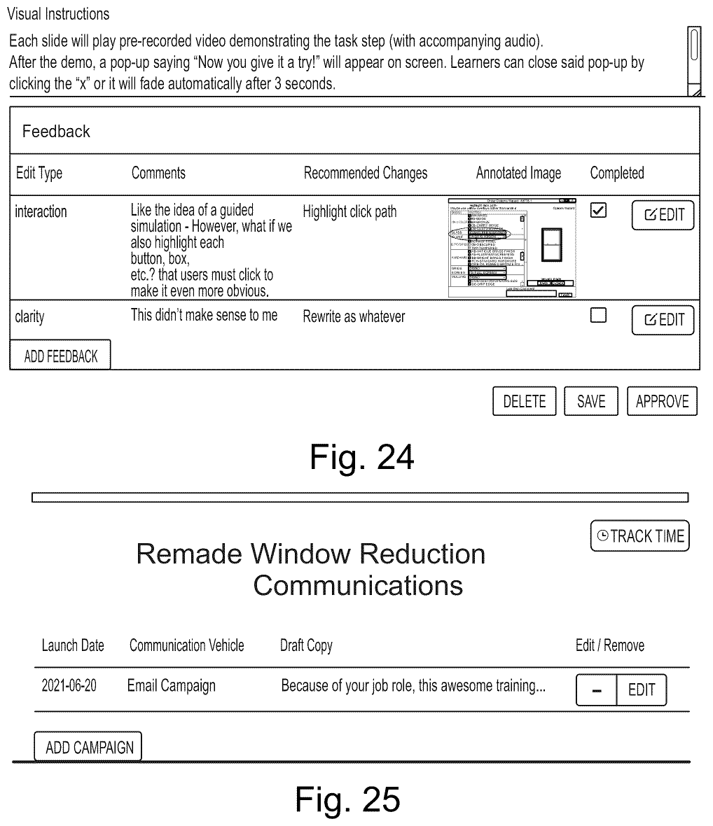

FIG. 23 and FIG. 24 show a feedback interface for the Storyboard Tool 157 sub-component in which reviewers can enter suggestions and request edits based upon the draft created by the author. The suggestions and edits fall into pre-defined edit types such as, “interaction,” and “clarity” and also allow the reviewer to upload her own images to explain a suggested edit. Reviewers save time using these pre-defined edits, and instruction developers save time by receiving categorized feedback. This feature further allows them to identify common issues quickly. For example, if multiple reviewers identify the need to address a lack of “clarity” during a particular section of the course, the learning developer can proceed with confidence that she needs to rework that section.

The project management module 150 may also include an Instructor-Led Instruction Templates 158 sub-component to provide templates which help to speed up development, to promote consistency and to support the facilitators who deliver instruction. The Instructor-Led Instruction Templates 158 sub-component allows users to jump in with both feet without struggling with cumbersome formatting issues.

The project management module 150 may also include an eLearning Recommendations 159 sub-component where the user would learn about eLearning tools, best design principles, and more with the eLearning recommendations tool.

The project management module 150 may also include a Production Review Tool 161 sub-component which provides a form to capture feedback from sponsors, and pilot groups which requires organization and a clear process. The Production Review Tool 161 sub-component creates structure and makes it easier on both those providing feedback and the learning professional responsible for implementing it. The Production Review Tool 161 sub-component structures the review process around common edits/areas that require revision.

The project management module 150 may also provide a job aid for recording audio, eLearning, video lessons, simulations, and even instructor-led classroom activities often incorporate audio.

The project management module 150 may further include a sub-component for Communication Campaign Tool 162 to drive awareness and desire to complete the instruction solution, both of which play as large a role in the success of a learning initiative as the content itself. Create messaging that not only explains the purpose behind the instruction solution, but demonstrates benefits thereof. In some embodiments, the Communication Campaign Tool 162 enables at least one user to create messaging associated with a developed instruction solution which is then provided along with a developed instruction solution to the at least one end user.

FIG. 25 shows the interface by which the user can create a communication campaign to support the rollout of the proposed instruction solution.

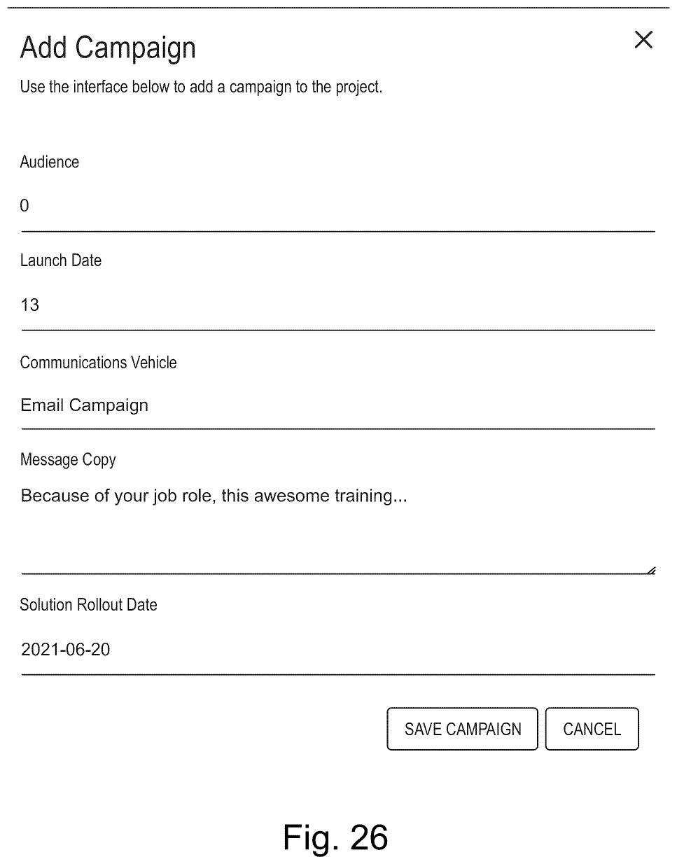

FIG. 26 shows a detailed view of a Communication Campaign Tool by which the user can customize the campaign.

The project management module 150 may also include a Functional Testing Tool 164. Just like manufacturing and service industries, learning and development professionals use quality control to put out the best possible product. The Functional Testing Tool 164 fills that need. In some embodiments, the Functional Testing Tool 164 provides functional testing for quality control of the developed instruction solution.

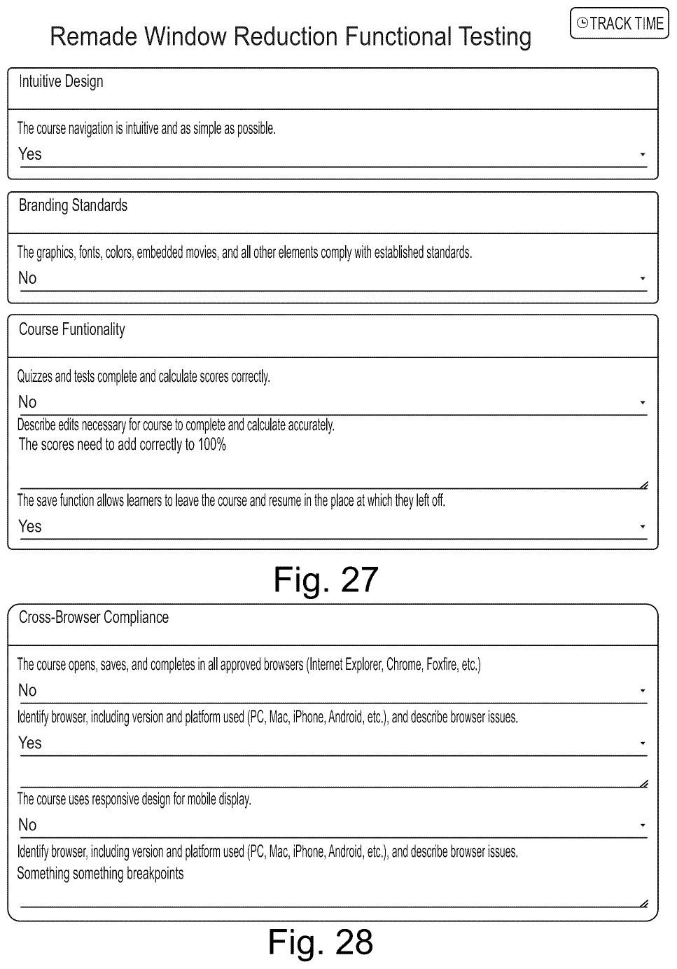

FIGS. 27 and 28 show the Functional Testing Tool 164 by which the user can check that eLearning instruction solutions operate as intended.

The project management module 150 may also include a Production Review Form 161 sub-component which provides a mechanism to capture feedback from sponsors, and pilot groups which requires organization and a clear process. The Production Review Form 161 sub-component creates structure and makes it easier on both those providing feedback and the learning professional responsible for implementing it.

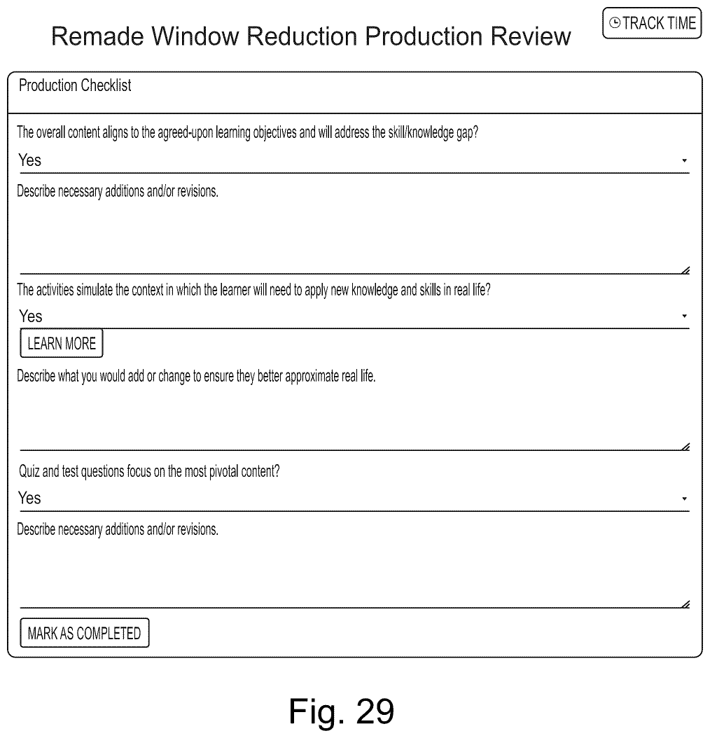

FIG. 29 shows a Production Checklist Tool by which the user also confirms that the completed instruction solution reflects the requirements outlined during the initial analysis phase and that the learning solution fulfills its intended purpose.

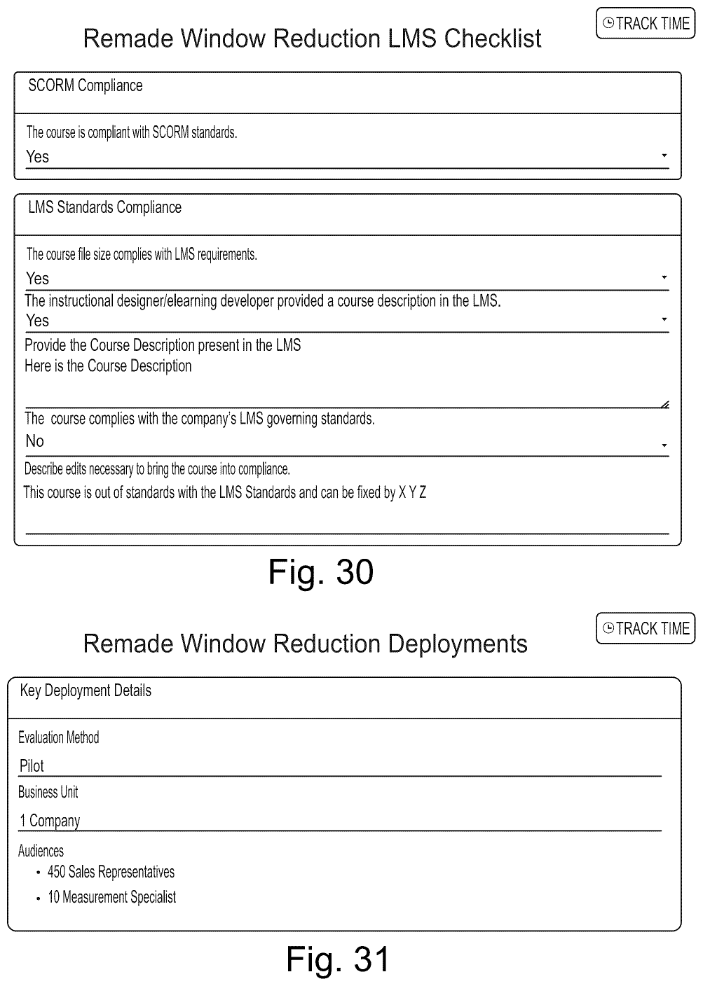

The project management module 150 may also include a learning management system (LMS) Checklist 166 sub-component. Most instruction solutions use a learning management system to act as the interface between content and the participant. The learning management system Checklist 166 sub-component provides a guardrail that outlines common requirements for an instruction solution to function in a learning management system Environment. FIG. 30 shows some of these requirements and that the system allows users to track them.

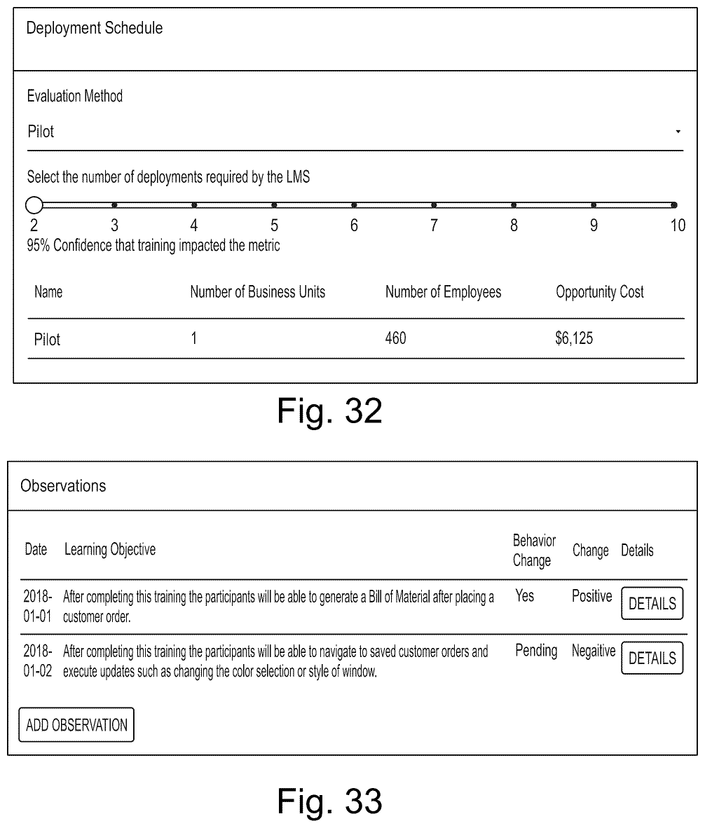

The project management module 150 may further include a Deployment Tool by which a user can organize an instruction rollout into separate groups for the purpose of measurement and A:B testing. Specifically, the Deployment Tool can divide large instruction audiences into even groups which allows for a staggered instruction rollout. Very large audiences make it difficult to track completions and may overtax a learning management system if too many learners use it at the same time. The Deployment Tool as seen in FIGS. 31 and 32 help alleviate this potential problem.

An Audience Prioritization 163 sub-component which performs as a guide to enhance impact and distribution to an appropriate audience. In some embodiments, the Audience Prioritization 163 includes an end user prioritization that defines a target end user. As such, the Audience Prioritization 163 sub-component increases success rates by narrowing a focus of the instruction solution to those who can put lessons into action. In some embodiments, the Audience Prioritization 163 sub-component describes who needs to take the training, which is a key piece of information.

The project management module 150 may also include a Functional Testing 164 sub-component. Just like manufacturing and service industries, learning and development professionals use quality control to put out the best possible product. The Functional Testing 164 sub-component fills that need. In some embodiments, the Functional Testing 164 sub-component provides functional testing for quality control of the developed instruction solution.

The project management module 150 may also include a User Experience Testing 165 sub-component. No product or service is perfect the first time. Apply user experience testing to capture feedback from an intended audience such as at least one end user of the developed instruction solution, for example.

With all the functions and applications in the project management module 150, it will provide measuring an impact of the instruction solutions, results, real-life impact, ROI and other information that the user or leadership desires.

FIG. 33 shows a Behavioral Evaluation Tool by which a user can observe whether or not an instruction solution correlates with behavior change on-the-job.

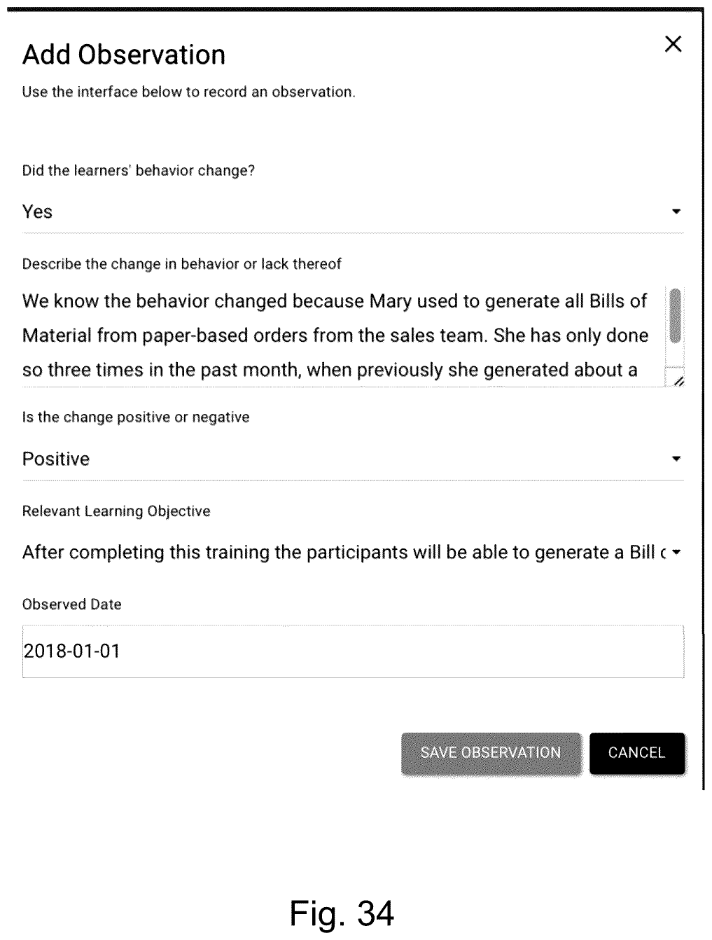

As FIG. 34 shows, the Behavioral Evaluation Tool allows users to align a targeted behavior change to specific learning objectives so they can assess the instruction solutions', capacity to affect a level 3 behavior change on the job as outlined by Kirkpatrick.

The project management module 150 as a whole, and in particular, a Measuring Instruction Impact Tool 167 sub-component, provides a framework to measure ROI of the developed instruction solution.

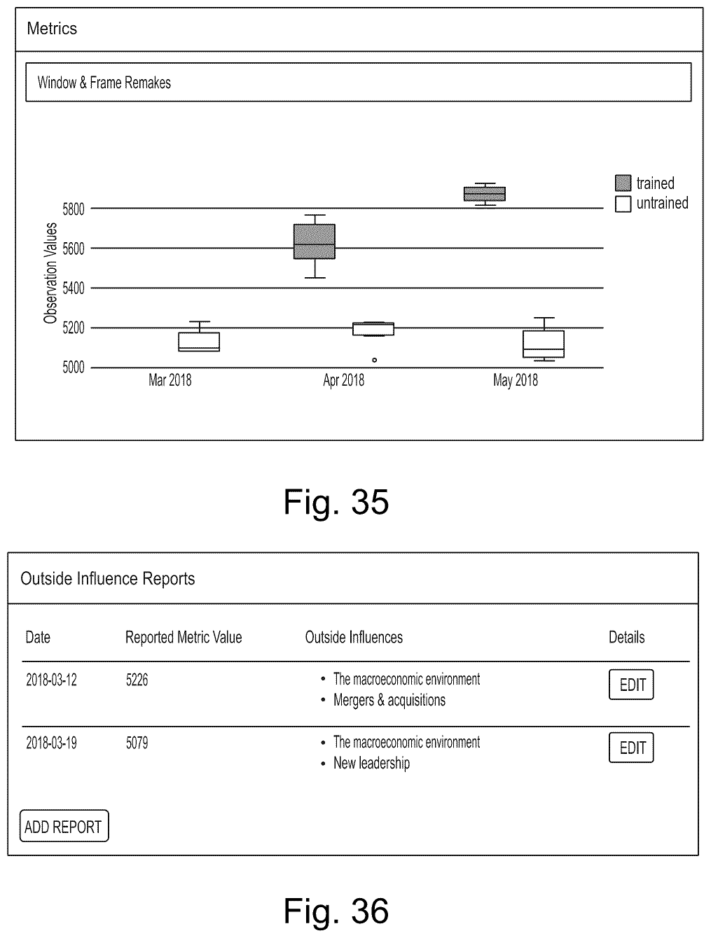

FIG. 35 shows the Metric Impact Evaluation Tool by which a user can compare the performance of a specific metric across a group that received an instruction versus one that did not.

FIG. 36 shows an additional Metric Impact Evaluation Tool, an Outside Influence Tracker, by which a user can document outside influences that may confound the metrics tracked in the tool of FIG. 35.

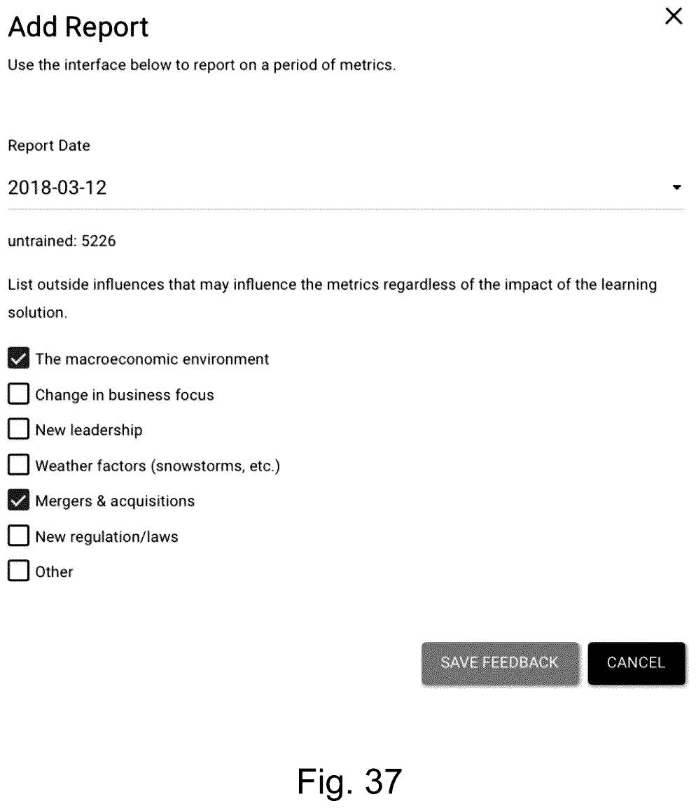

FIG. 37 shows a detailed view of the Outside Influence Tracker so a user may document factors besides an instruction solution that could influence movement in a given metric. When looking at correlations this capability is key in determining the degree to which a correlation may be due to chance rather than illustrate a causal effect.

The user can alter the display settings for the project management module 150, such as color, font, and logo when exporting or saving their forms, for example.

The parameter module 160 of the system 1 may include the eLearning Timeline and Cost Calculator 168. The eLearning Timeline and Cost Calculator 168 may apply geographic-specific market analysis and requirement inputs to provide total costs in both hours and money necessary to build the instruction solutions. The eLearning Timeline and Cost Calculator 168 may be used to sum up the costs of the instruction solutions. The eLearning Timeline and Cost Calculator 168 may be specific to the creation of proposed instruction solutions. The parameter module 160 may be configured to estimated parameters such as time and cost for the instruction solutions, for example. The parameter module 160, and more particularly the eLearning Timeline and Cost Calculator 168 provides parameter estimates such as elapsed time and “real” actual time to provide an additional layer of information. The parameter module 160 may access from a lookup table (See FIG. 38) stored in the memory 214 at least one value associated with the one or more features of the proposed instruction solution and generate the at least one parameter estimate based upon at least one value associated with the one or more features of the proposed instruction solution. Such features of the proposed instruction solutions may include at least one of a desired time duration thereof, an audio narration, a desired level of interactivity, a desired level of custom animation, a desired level of graphics, an imbedded video, a support of a cultural shift that requires a change management plan, a number of learning resources, a desired level of measurement, a desired form of delivery, a use of existing subject matter expert-provided content, a complexity of instruction topic, a use of pre-existing templates, a use of a rapid development tool, a use of a learning management system to house and distribute the instruction solution, and a time dedication for development. For example, the time dedication feature may be indicative a project length given a work rate (i.e., a project that would take eight weeks at forty hours per week or sixteen weeks at twenty hours per week).

In some embodiments, the at least one value may be a work effort adjustment value to account for the fact that no one can dedicate 100 percent of their workday to a specific project. The at least one value may be a weighted adjustment to account for the fact that not all requirements impact time and cost equally.

The parameter module 160 of the system 1 may utilize a cost screen (see FIG. 17) that may allow a calculation of the costs associated with the proposed instruction solution. As depicted, it may include a breakdown of the expense including description, the category, the cost and any notes about the cost. More than one cost may be included and shown.

The parameter module 160 of the system 1 may also include one or more of the instructor-led instruction (ILI) calculator 169. The parameter module 160 may access from a lookup table (See FIG. 49) stored in the memory 214 at least one value associated with the one or more features of the proposed instruction solution and generate the at least one parameter estimate based upon at least one value associated with the one or more features of the proposed instruction solution. The parameter module 160 applies a custom, requirements-based calculator 169 specific to the process of building the instructor-led instruction solutions. The parameter module 160 may include its own internal weighting system to account for the varying degree of importance of each requirement and outputs estimates in both actual and elapsed time. Additionally, the parameter module 160 of the system 1 enables the user to adjust the final cost total based upon user-entered hourly rates. The ILI calculator 169 of the parameter module 160 may include input screens. The ILI calculator 169 may have a project overview. The parameter module 160 of the system 1 may include a project name entered into the ILI calculator 169 as well as if an external instruction solution package is purchased. Inputs may include features of the proposed instruction solution such as how long the course will run, the amount of interactivity the course requires, the complexity of the course topic, the existence and availability of pre-existing templates when building course materials, and the existence and availability of existing subject-matter-expert-provided content such as PowerPoints, documents, process designs, talking points, job aids, or other material specific to the training topic.

The parameter module 160 of the system 1 may save these inputs and/or features or the proposed instruction solution and continue on to more inputs and/or features of the proposed instruction solution.

The parameter module 160 of the system 1 may include an input and/or feature of level of graphics and animation, the use of video for messaging such as a welcome from leadership, the use of video for activities such as scenarios or case studies, the use of pre-recorded audio, or other supplemental materials for the course.

The parameter module 160 of the system 1 may save these inputs and/or features or the proposed instruction solution and continue on to more inputs and/or features of the proposed instruction solution.

The parameter module 160 of the system 1 may include an input and/or feature to document if the course requires train-the-trainer support prior to delivering it to learners, if a pre-established and available location in which to deliver the course to in-person participants exists, the use of a learning management system in conjunction with course delivery, if the course supports a cultural shift that requires a change management plan, and the desired level of measurement.

The parameter module 160 of the system 1 may save these inputs and/or features or the proposed instruction solution and continue on to more inputs and/or features of the proposed instruction solution.

The system 1 may be configured to transmit, via the at least one program and the at least one computing device 110, 112, and 114, at least one communication prior to a development of the proposed instruction solution, wherein the communication includes at least one of the estimated parameters for determination of whether the development of the proposed instruction solution is desired.

In some embodiment, for any form on the system 1, there is an option to output as a PDF, save, and print.

The user may also create instruction modules within a larger instruction solution. All forms can be saved and printed. At least one of the calculators 168, 169 of the parameter module 160 may be employed to generate at least one estimate parameter such as time and cost, for example, to develop the proposed instruction solution using the at least one value associated with the one or more features of the proposed instruction solution.

The present disclosure provides a ROI cost benefit by providing information about the ROI Cost: Benefit functionality of the present disclosure.

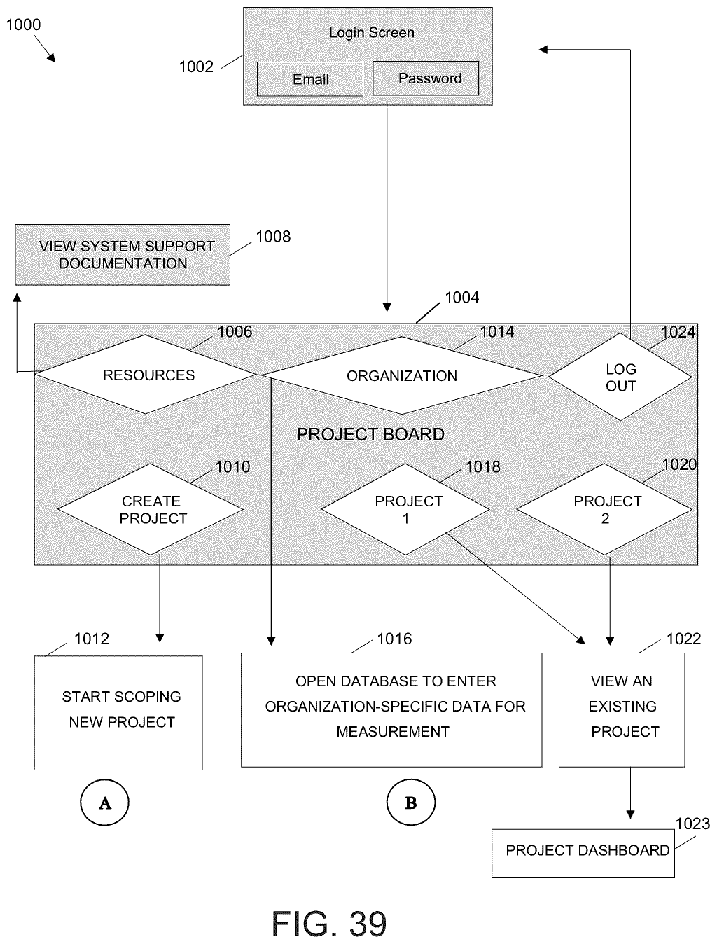

FIGS. 39-48 illustrate an exemplary method 1000 of the system 1 in accordance with an embodiment of the presently disclosed subject matter. At step 1002, a user inputs an email and a password to log into the system 1. A project board 1004 is then displayed via a user interface of the computing device 110, 112, and 114. As shown in FIG. 39, the user may then select “Resources” 1006 to view system support documentation at step 1008, “Create Project” 1010 to start scoping a new project at step 1012, “Organization” 1014 to open a database 140 to enter organization-specific data for measurement at step 1016, existing project (e.g. “Project 1” 1018, “Project 2” 1020) to view and/or work on an existing project at step 1022 using a project dashboard 1023, and/or “Log Out” 1024 to exit the system 1.

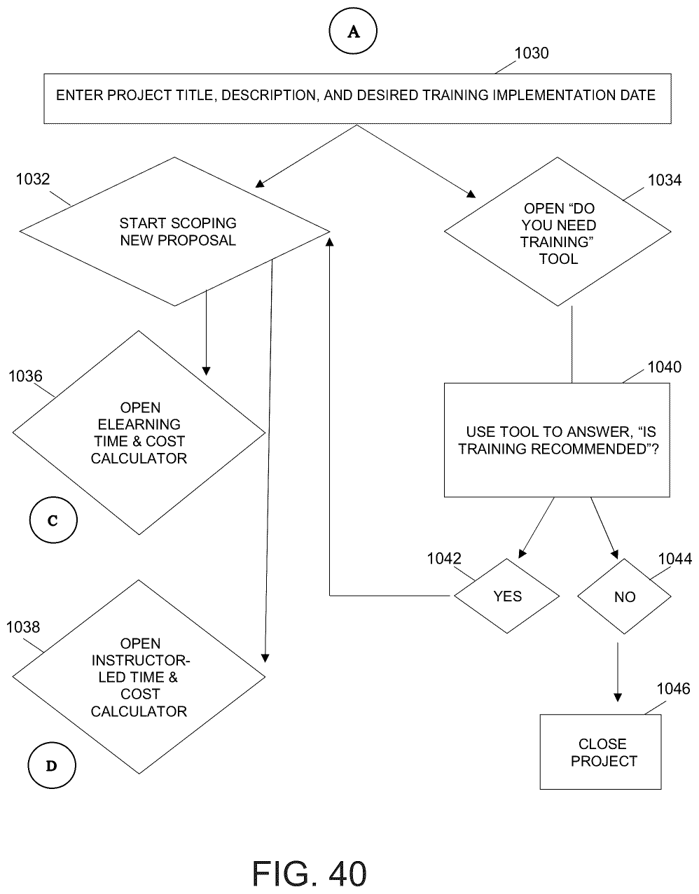

When the user selects “Create Project” 1010, the user, as illustrated in FIG. 40, may enter at least one of a project title, a description, and a desire instruction solution implementation date, at step 1030. Thereafter, the user may then start scoping a new proposal, at step 1032, or alternatively open “Do You Need Training” tool, at step 1034. If scoping a new proposal is desired, the user may open an eLearning Time and Cost Calculator 168, at step 1036, or alternatively open an Instructor-Led Time and Cost Calculator 169, at step 1038, which are both described hereinafter. If the user selects the “Do You Need Training” tool, the user, at step 1040, may use the tool to answer “Is training recommended?” When the user positively answers “Is training recommended?” at step 1042, the user may then start scoping a new proposal at step 1032. Conversely, when the user negatively answers “Is training recommended?” at step 1044, the project is closed at step 1046.

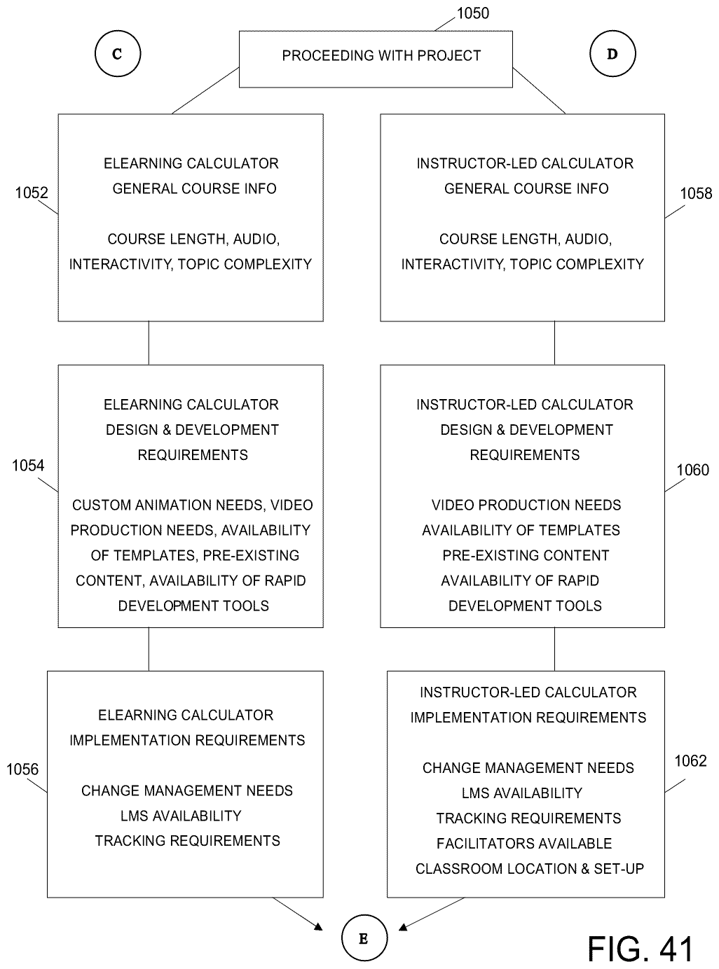

FIG. 41 illustrates the eLearning Time and Cost Calculator 168 of step 1036 and the Instructor-Led Time and Cost Calculator 169 of step 1038. At step 1050, the user may proceed with the project. If the eLearning Time and Cost Calculator 168 was selected at step 1036, the user inputs, at step 1052, eLearning Calculator 168 general course information or instruction solution features such as course length, audio, interactivity, and/or topic complexity, for example. At step 1054, the user inputs eLearning Calculator 168 design and development requirements or additional instruction solution features such as custom animation needs, video production needs, availability of templates, pre-existing content, and/or availability of rapid development tools, for example. Additionally, at step 1056, the user inputs eLearning Calculator 168 implementation requirements or further instruction solution features such as change management needs, learning management system availability, and/or tracking requirements, for example.

Alternatively, if the Instructor-Led Time and Cost Calculator 169 was selected at step 1038, the user inputs, at step 1058, Instructor-Led Calculator 169 general course information or instruction solution features such as course length, audio, interactivity, and/or topic complexity, for example. At step 1060, the user inputs Instructor-Led Calculator 169 design and development requirements or additional instruction solution features such as video production needs, availability of templates, pre-existing content, and/or availability of rapid development tools, for example. Additionally, at step 1062, the user inputs Instructor-Led Calculator 169 implementation requirements or further instruction solution features such as change management needs, learning management system availability, tracking requirements, facilitators available, and/or classroom location and set-up, for example.

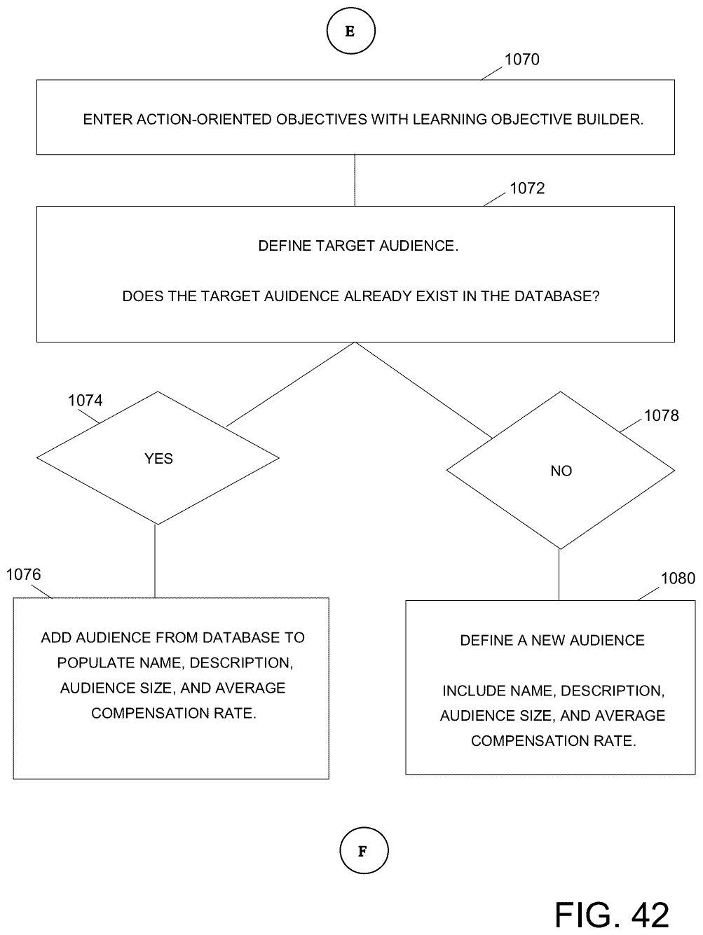

As illustrated in FIG. 42, when either the eLearning Calculator 168 implementation requirements, at step 1056, or the Instructor-Led Calculator 169 implementation requirements, at step 1062, has been inputted, the user, at step 1070, may then enter action-oriented objectives with a learning objective builder such as the Learning Objective Tool 152, for example. At step 1072, the user may define a target audience. If the target audience already exist in the database 140 at step 1074, the user may add audience from the database 140 to populate a name, a description, an audience size, and/or an average compensation rate, for example, at step 1076. If the target audience does not already exist at step 1078, the user may define a new audience including, but not limited to, a name, a description, an audience size, and/or an average compensation rate, for example, at step 1080.

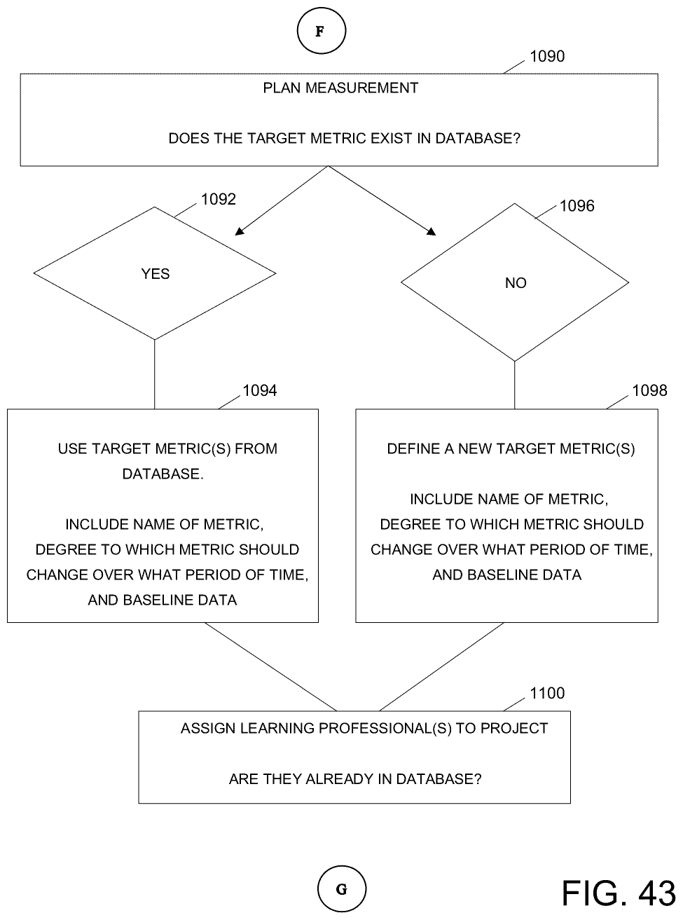

At step 1090, the user may proceed to plan measurement, as shown in FIG. 43. If a target metric exists in the database 140 at step 1092, the user, at step 1094, may use one or more target metrics from the database 140 including, but not limited to, a name of metric, a degree to which a metric should change over a period of time, and/or a baseline data, for example. If a target metric does not exist in the database 140 at step 1096, the user, at step 1098, may define one or more target metrics including, but not limited to, a name of metric, a degree to which a metric should change over a period of time, and/or a baseline data, for example. When either the target metrics from the database 140 are used, at step 1094, or the new metrics defined, at step 1098, the user, at step 1100, may then assign one or more learning professionals to the project.

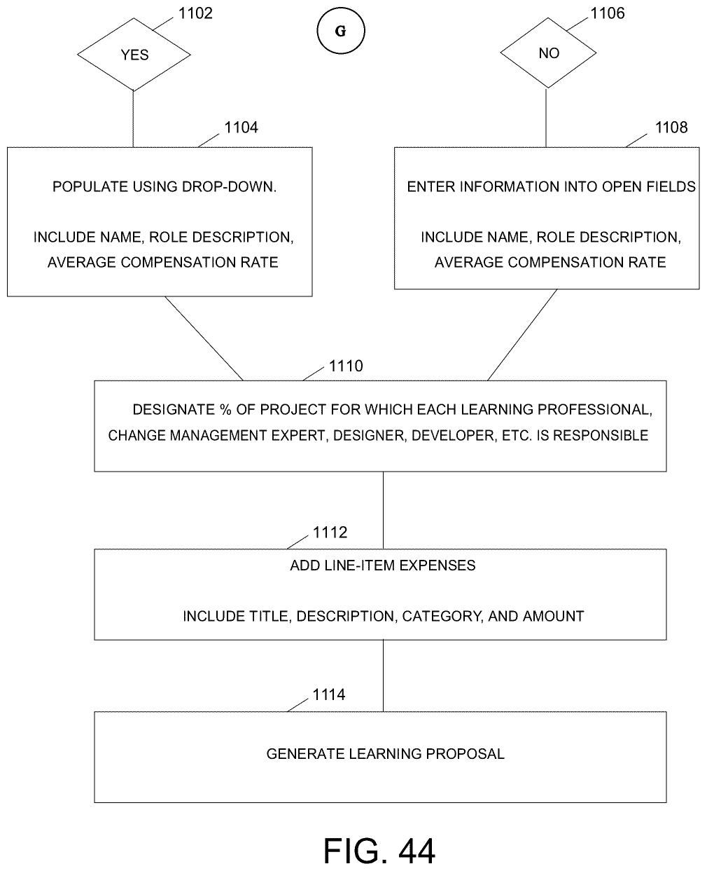

As depicted in FIG. 44, if the one or more learning professionals exist in the database 140 at step 1102, the user, at step 1104, may use one or more learning professionals from the database 140 including, but not limited to, a name, a role description, and/or an average compensation rate, for example. In some embodiments, the user, at step 1104, may populate the system 1 using a drop-down option. If the one or more learning professionals do not exist in the database 140 at step 1106, the user, at step 1108, may define one or more learning professionals including, but not limited to, a name, a role description, and/or an average compensation rate, for example. In some embodiments, the user, at step 1108, may input the one or more learning professionals into the system 1 using open fields. When either the one or more learning professionals from the database 140 are used, at step 1104, or the one or more learning professional are newly entered, at step 1108, the user, at step 1110, may then designate a percentage of the project for which each of the one or more learning professionals, a change management expert, a designer, a developer, and/or the like, for example, is responsible. At step 1112, the user may further add line-item expenses including, but not limited to, a title, a description, a category, and/or an amount, for example. The user, at step 1114, may then generate a proposed instruction solution (i.e., a learning proposal).

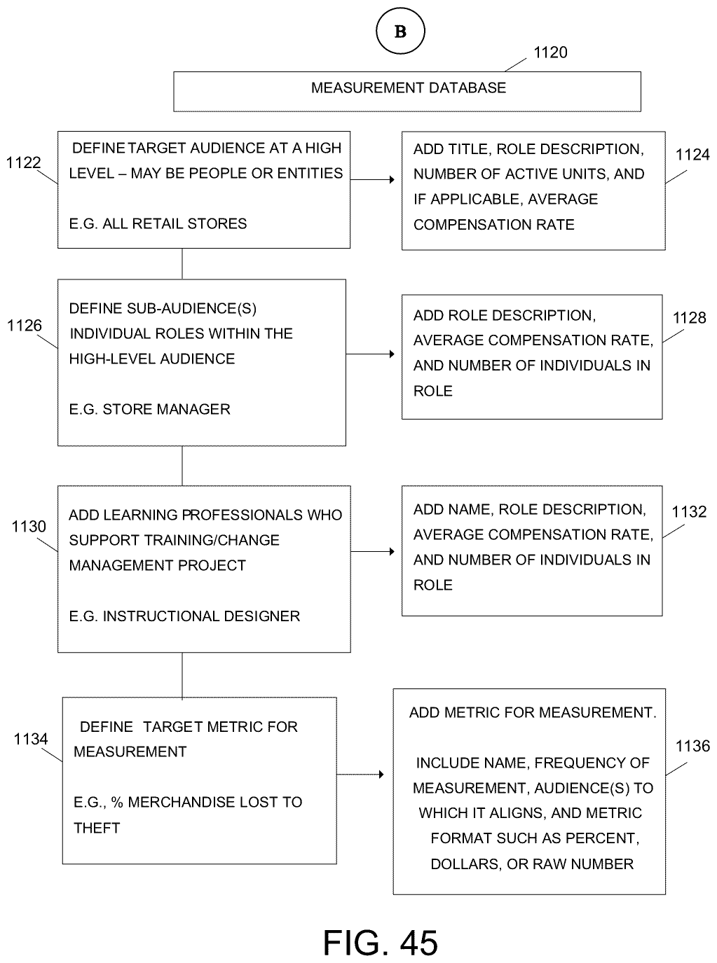

Referring back to FIG. 39, the user may select “Organization” 1014 to open a measurement database to enter organization-specific data for measurement at step 1016. FIG. 45 illustrates a process 1120 for the measurement database of FIG. 39. At step 1122, the user may define a target audience at a high-level such as people and/or entities. For example, the target audience may be all retail stores. The user, at step 1123, may add a title, a role description, a number of active units, and/or an average compensation rate, for example. At step 1126, the user may further define one or more sub-audiences such as individual roles within the high-level audience. For example, the sub-audience may be a store manager. The user, at step 1128, may add a role description, an average compensation rate, and/or a number of individuals in the role, for example. At step 1130, the user may add one or more learning professional who support the proposed instruction solutions/change management projects. For example, the learning professional may be an instruction solution designer. The user, at step 1132, may add a name, a role description, an average compensation rate, and/or a number of individuals in the role, for example. At step 1134, the user may define a target metric for measurement such as a percentage merchandise lost to theft, for example. The user, at step 1136, may add the metric for measurement including, but not limited to, a name, a frequency of measurement, one or more audiences to which it aligns, and/or a metric format (e.g. a percent, dollars, a raw number, and the like), for example.

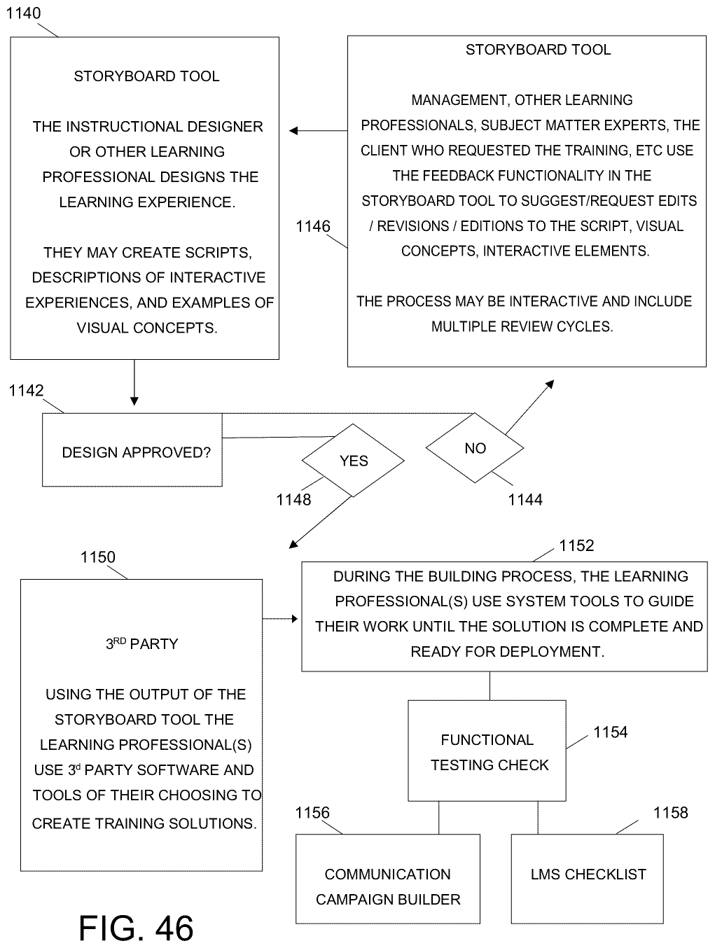

Now turning to FIG. 46, which depict a process of the Storyboard Tool 157. At step 1140, the user, the instruction designer, and/or other learning professional may design the proposed instruction solution or learning experience. In some embodiments, the user, the instruction designer, and/or other learning professional may develop at least one of scrips, description of interactive experiences, and/or examples of visual concepts, for example. At step 1142, the user may indicate whether the design of step 1140 has been approved. If the design has not been approved at step 1144, the user, management, other learning professionals, subject matter experts, the client who requested the proposed instruction solution, and/or the like, at step 1146 may use a feedback functionality in the storyboard tool to suggest and/or request at least one of edits, revisions, edition to the script, visual concepts, and/or interactive elements. In certain embodiments, the process of the Storyboard Tool 157 may be iterative and include multiple review cycles.

If the design has been approved at step 1148, the user and/or the learning professionals, at step 1150, may use the output of the Storyboard Tool 157 along with a third-party software and/or additional tools to create the one or more instruction solutions. At step 1152, during a building process, the user and/or the learning professionals may use system tools to guide a work thereof until the proposed instruction solution is complete and/or ready for development. At step 1154, the user may perform a functional testing check. Thereafter, the user may utilize a communication campaign tool 162 at step 1156 and/or a learning management system Checklist 166 at step 1158.

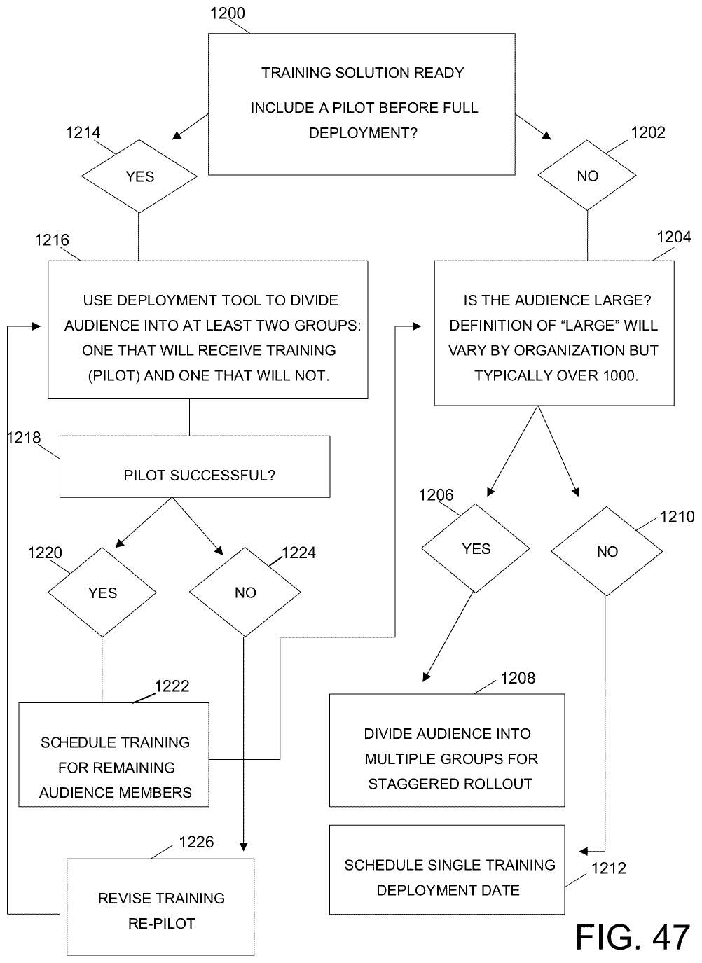

FIG. 47 illustrates a process for deployment and/or implementation tools. At step 1200, the user evaluates whether the proposed instruction solution is ready for development. In some embodiments, the user may determine whether to include a pilot prior to full development.

If the pilot is not desired at step 1202, the user may determine whether the audience is relatively large at step 1204. In certain embodiments, a relatively large audience will be greater than 1000 individuals. It is understood, however, that number of a relatively large audience may vary by organization. When the audience is relatively large at step 1206, the user, at step 1208, may divide the audience into multiple groups for staggered rollout. Contrarily, when the audience is not relatively large at step 1210, the user, at step 1212, may schedule a single date of deployment of a developed instruction solution.

If the pilot is desired at step 1214, the user, at step 1216, may use the deployment and/or implementation tools to divide the audience into a plurality of groups at least one of the groups may receive training use a pilot of the instruction solution and another one of the groups may not receive any training. At step 1218, the user may determine whether the pilot was successful. If the pilot is successful at step 1220, the user, at step 1222, may schedule the instruction solution for a remaining portion of the audience. Thereafter, the user may proceed to step 1204 as discussed hereinabove. If the pilot is not successful at step 1224, the user, at step 1226, may revise the proposed instruction solution and repeat the pilot starting at step 1216.

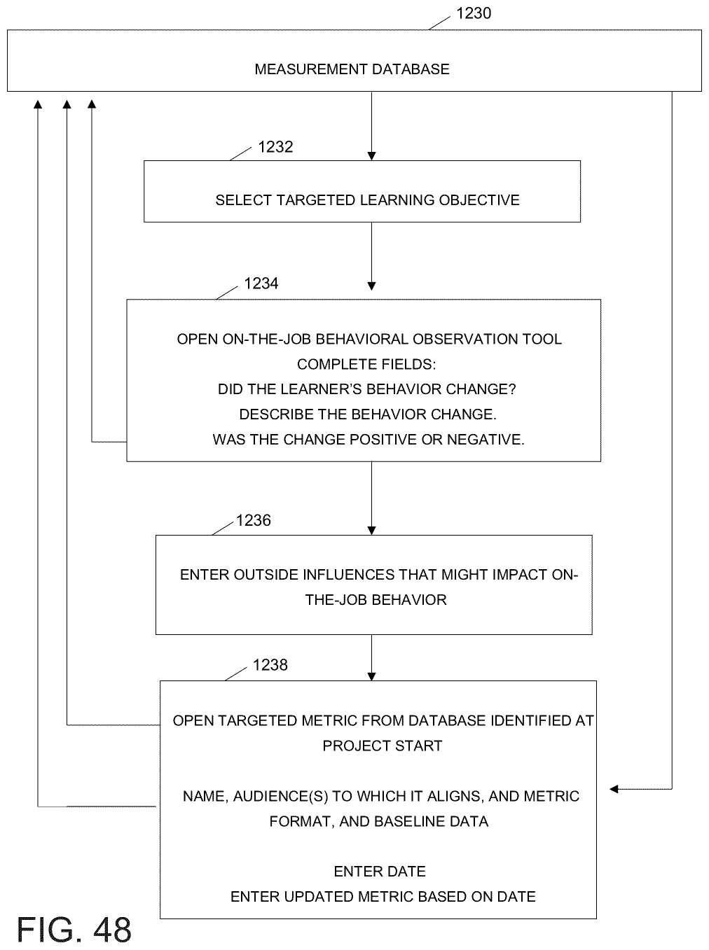

FIG. 48 illustrates a process for measurement tools. At step 1230, the process starts with the measurement database. At step 1232, the user may select one or more targeted learning objectives. At step 1234, the user may open on-the-job behavioral observation tool and complete at least one of the fields: Did the learner's behavior change?; Describe the behavior change; and/or was the change positive or negative. Thereafter, the process may repeat step 1230. Alternatively, the process proceeds to step 1236, in which, the user may enter outside influences that may impact on-the-job behavior. Then, at step 1238, the user may open targeted metric from the database 140 identified at the project start; identify at least one of a name, an audience to which the targeted metric aligns, a metric format, and a baseline data; enter a date; and/or enter an updated metric based on the date. Thereafter, the process may repeat step 1230. Alternatively, the process may process from step 1230 directly to step 1238 described hereinabove.

As to a further discussion of the manner of usage and operation of the present disclosure, the same should be apparent from the above description. Accordingly, no further discussion relating to the manner of usage and operation will be provided. With respect to the above description, it is to be realized that the optimum dimensional relationships for the parts of the present disclosure, to include variations in size, materials, shape, form, function and manner of operation, assembly and use, are deemed readily apparent, and all equivalent relationships to those illustrated in the drawings and described in the specification are intended to be encompassed by the present disclosure. Example embodiments are provided so that this disclosure will be thorough, and will fully convey the scope. Numerous specific details are set forth such as examples of specific components, devices, and methods, to provide a thorough understanding of embodiments of the present disclosure. It will be apparent that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A method of developing an instruction solution, comprising:
providing at least one computing device in communication with a memory; and at least one program stored in the memory, the program having a plurality of components, wherein one of the components is a project management module, and another one of the components is a parameter module;
receiving from at least one source, via the at least one computing device, one or more features of a proposed instruction solution;
accessing from the memory at least one value associated with the one or more features of the proposed instruction solution;
generating, via the at least one program and the at least one computing device, at least one estimated parameter to develop the proposed instruction solution using the at least one value associated with the one or more features of the proposed instruction solution; and
transmitting, via the at least one program and the at least one computing device, at least one communication prior to a development of the proposed instruction solution, wherein the communication includes at least one of the estimated parameters for determination of whether the development of the proposed instruction solution is desired.

2. The method of claim 1, wherein the project management module uses at least one of scoping tools, questionnaires, timelines, design templates, development templates, measurement tools, and implementation guides.

3. The method of claim 1, wherein the project management module is configured to determine if development of the proposed instruction solution is necessary.

4. The method of claim 1, wherein the project management module includes a learning objective tool.

5. The method of claim 1, wherein the project management module includes a learning objective tool that provides a foundation of the proposed instruction solution by outlining at least one target that correlates to at least one of an objective of at least one of at least one operator and the at least one end user.

6. The method of claim 1, wherein the project management module includes at least one of an electronic-learning development checklist, an instructor-led development checklist, and a learning management system checklist.

7. The method of claim 1, wherein the project management module includes at least one storyboard tool, and wherein the at least one storyboard tool provides a structure to create at least one of a script, an outline of visual concepts, and a structure of content flow.

8. The method of claim 1, wherein the project management module includes a storyboard tool that provides predefined common edits for learning scripts and centralizes reviewer feedback.

9. The method of claim 1, wherein the project management module includes at least one instructor-led instruction template.

10. The method of claim 1, wherein the project management module includes a production review tool that captures feedback from at least one operator of a developed instruction solution.

11. The method of claim 1, wherein the project management module includes a communication campaign tool that enables at least one operator to create messaging associated with a developed instruction solution which is then provided along with the developed instruction solution to the at least one end user.

12. The method of claim 1, wherein the project management module includes an end user prioritization that defines at least one target end user.

13. The method of claim 1, wherein the project management module includes functional testing for quality control of a developed instruction solution.

14. The method of claim 1, wherein the project management module includes user experience testing that captures feedback from the at least one end user of the developed instruction solution.

15. The method of claim 1, wherein the parameter module is configured to provide a timeline for an electronic-learning solution.

16. The method of claim 1, wherein the parameter module calculates the cost estimate of the proposed instruction solution based upon at least one of requirement inputs and a labor rate of at least one operator tasked to develop the proposed instruction solution.

17. The method of claim 1, wherein the parameter module is configured to estimate labor hours required to develop the proposed instruction solution.

18. The method of claim 1, wherein the project management module includes a measuring instruction impact tool that provides a framework to measure the return on investment of the developed instruction solution.

19. The method of claim 1, wherein the one or more features of the proposed instruction solution includes at least one of a desired time duration thereof, an audio narration, pre-recorded audio, a desired level of interactivity, a desired level of custom animation, a desired level of graphics, at least one imbedded video, a support of a cultural shift that requires a change management plan, a number of learning resources, a desired level of measurement, a desired form of delivery, a use of existing subject matter expert-provided content, a complexity of instruction topic, a use of pre-existing templates, a use of a rapid development tool, a desired level of trainer-to-trainer support, a desired location for delivery, a use of a learning management system to house and distribute the instruction solution, and a time dedication for development.

20. A instruction development system, comprising:
at least one computing device in communication with a memory; and
at least one program stored in the memory, the program having a plurality of components, wherein one of the components is a project management module, and another one of the components is a parameter module, wherein the instruction development system is configured to:
receive from at least one source, via the at least one computing device, one or more features of a proposed instruction solution;
access from the memory at least one value associated with the one or more features of the proposed instruction solution;
generate, via the at least one program and the at least one computing device, at least one estimated parameter to develop the proposed instruction solution using the at least one value associated with the one or more features of the proposed instruction solution; and
transmit, via the at least one program and the at least one computing device, at least one communication prior to a development of the proposed instruction solution, wherein the communication includes at least one estimated parameter for determination of whether the development of the proposed instruction solution is desired.
